(19) United States
(12) Patent Application Publication
(10) Pub. No.: US 2013/0258913 A1
(43) Pub. Date: Oct. 3, 2013

(54) TDD PIPELINE PROCESSING

(71) Applicant: QUALCOMM INCORPORATED, San Diego, CA (US)

(72) Inventors: Raghu N. Challa, San Diego, CA (US); Lei Ke, San Diego, CA (US); Pillappakkam Bahukutumbi Srinivas, San Diego, CA (US)

(73) Assignee: QUALCOMM Incorporated, San Diego, CA (US)

(21) Appl. No.: 13/840,604

(22) Filed: Mar. 15, 2013

Related U.S. Application Data
(60) Provisional application No. 61/618,473, filed on Mar. 30, 2012.
(60) Provisional application No. 61/618,423, filed on Mar. 30, 2012.

(51) Int. Cl. H04J 3/06

(52) U.S. Cl. CPC H04J 3/06
USPC 370/280

(57) ABSTRACT

Pipeline automatic gain control (AGC) processing is conducted by a mobile device when preparing for reception of one or more synchronization signals in a cell, when the mobile device has no knowledge of a timing and/or configuration of the synchronization signals in the cell. The mobile device triggers selection of a particular set of pipeline AGC processing operations and sets an amplifier with an amplifier gain setting determined by the selected set of pipeline AGC processing operations.

### CROSS-REFERENCE TO RELATED APPLICATIONS

This application claims the benefit of U.S. Provisional Patent Application No. 61/618,473, entitled, “TDD PIPELINE PROCESSING”, filed on Mar. 30, 2012, and U.S. Provisional Patent Application No. 61/618,423, entitled, “SIGNAL POWER MEASUREMENT WINDOWS IN PIPELINE AGC PROCESSING”, filed on Mar. 30, 2012, which are expressly incorporated by reference herein in their entirety.

### BACKGROUND

1. Field

Aspects of the present disclosure relate generally to wireless communication systems, and more particularly, to time division duplex (TDD) pipeline processing.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the wireless technologies not only to meet the growing demand for mobile broadband access, but to advance and enhance the user experience with mobile communications.

### SUMMARY

Representative aspects of the present disclosure are directed to a method of pipeline automatic gain control (AGC) processing in wireless communication. The method includes preparing, by a mobile device, for reception of one or more synchronization signals in a cell, wherein the mobile device has no knowledge of a timing of the one or more synchronization signals in the cell, triggering, by the mobile device, selection of a set of pipeline automatic gain control (AGC) processing operations, and setting, by the mobile device, an amplifier of the mobile device with an amplifier gain setting determined by the selected set of pipeline AGC processing operations.

Additional representative aspects of the present disclosure are directed to an apparatus of pipeline AGC processing in wireless communication. The apparatus includes means for preparing, by a mobile device, for reception of one or more synchronization signals in a cell, wherein the mobile device has no knowledge of a timing of the one or more synchronization signals in the cell, means for triggering, by the mobile device, selection of a set of pipeline AGC processing operations, and means for setting, by the mobile device, an amplifier of the mobile device with an amplifier gain setting determined by the selected set of pipeline AGC processing operations.

Further representative aspects of the present disclosure are directed to a computer program product for wireless communications in a wireless network that includes a non-transitory computer-readable medium having program code recorded thereon. The program code includes code for causing a computer to prepare, by a mobile device, for reception of one or more synchronization signals in a cell, wherein the mobile device has no knowledge of a timing of the one or more synchronization signals in the cell, code for causing a computer to trigger, by the mobile device, selection of a set of pipeline AGC processing operations, and code for causing a computer to set, by the mobile device, an amplifier of the mobile device with an amplifier gain setting determined by the selected set of pipeline AGC processing operations.

Still further representative aspects of the present disclosure relate to an apparatus configured for wireless communication that includes at least one processor and a memory coupled to the processor. The processor is configured to prepare, by a mobile device, for reception of one or more synchronization signals in a cell, wherein the mobile device has no knowledge of a timing of the one or more synchronization signals in the cell, to trigger, by the mobile device, selection of a set of pipeline AGC processing operations, and to set, by the mobile device, an amplifier of the mobile device with an amplifier gain setting determined by the selected set of pipeline AGC processing operations.

### BRIEF DESCRIPTION OF THE DRAWINGS

FIG. 1 is a block diagram conceptually illustrating an example of a mobile communication system.

FIG. 2 shows a block diagram of a design of a base station/eNB and a UE, which may be one of the base stations/eNBs and one of the UEs in FIG. 1.

FIG. 3 is a block diagram illustrating subframes of a communication stream.

FIG. 4 is a block diagram illustrating a communication stream.

FIG. 5 is a timing diagram illustrating signal power measurement timing for pipeline automated gain control (AGC) processing configured according to one aspect of the present disclosure.

FIG. 6 is a diagram illustrating the signal power measurement window configured according to one aspect of the present disclosure.

FIG. 7 is a timing diagram illustrating signal power measurement timing for pipeline AGC processing configured according to one aspect of the present disclosure.

FIG. 8 is a diagram illustrating the signal power measurement window configured according to one aspect of the present disclosure.

FIGS. 9A-9C are block diagrams illustrating a portion of an example transmission stream according to various aspects of the present disclosure.

FIG. 10 is a functional block diagram illustrating example blocks executed to implement one aspect of the present disclosure.

FIG. 11 is a timing diagram illustrating a pipeline AGC process configured according to one aspect of the present disclosure.

FIG. 12 is a timing diagram illustrating a communication stream configured for unified pipeline AGC processing according to one aspect of the present disclosure.

FIG. 13 is a timing diagram illustrating a communication stream divided into ticks for unified pipeline AGC processing according to one aspect of the present disclosure.

FIG. 14 is a timing diagram illustrating a communication stream divided into ticks for unified pipeline AGC processing according to one aspect of the present disclosure.

FIG. 15 is a timing diagram illustrating a communication stream divided into ticks for unified pipeline AGC processing according to one aspect of the present disclosure.

FIG. 16 is a timing diagram illustrating a communication stream divided into ticks for unified pipeline AGC processing according to one aspect of the present disclosure.

FIG. 17 is a functional block diagram illustrating example blocks executed to implement one aspect of the present disclosure.

FIG. 18 is a functional block diagram illustrating example blocks executed to implement one aspect of the present disclosure.

FIGS. 19A and 19B are timing diagrams illustrating pipeline AGC processing according to aspects of the present disclosure.

FIG. 20 is a block diagram illustrating X2L Connected mode gap scheduling according to one aspect of the present disclosure.

FIG. 21 is a block diagram illustrating a mobile device configured according to one aspect of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The techniques described herein may be used for various wireless communication networks such as CDMA, TDMA, FDMA, OFDMA, SC-FDMA and other networks. The terms “network” and “system” are often used interchangeably. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies mentioned above, as well as other wireless networks and radio access technologies. For clarity, certain aspects of the techniques are described below for LTE or LTE-A (together referred to in the alternative as “LTE/-A”) and use such LTE/-A terminology in much of the description below.

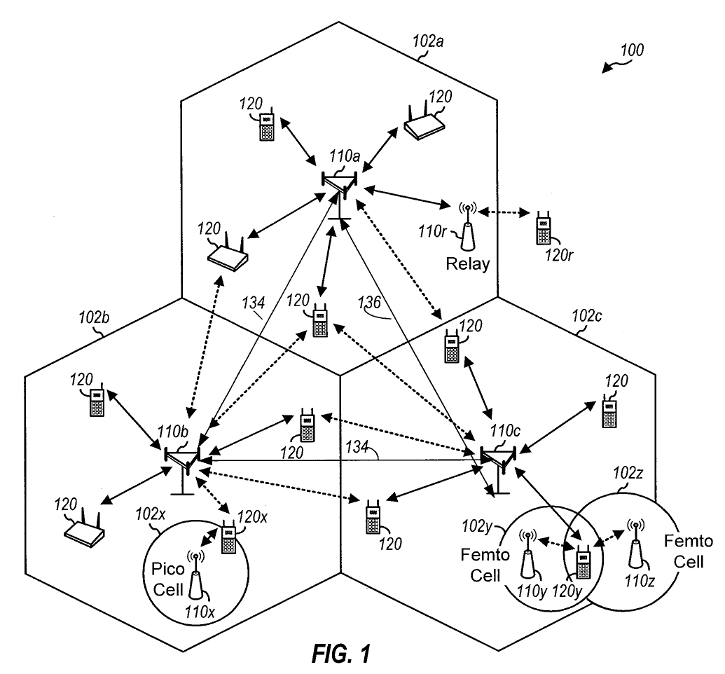

FIG. 1 shows a wireless network 100 for communication, which may be an LTE-A network. The wireless network 100 includes a number of evolved node Bs (eNBs) 110 and other network entities. An eNB may be a station that communicates with the UEs and may also be referred to as a base station, a node B, an access point, and the like. Each eNB 110 may provide communication coverage for a particular geographic area. In 3GPP, the term “cell” can refer to this particular geographic coverage area of an eNB and/or an eNB subsystem serving the coverage area, depending on the context in which the term is used.

An eNB may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. In the example shown in FIG. 1, the eNBs 110a, 110b and 110c are macro eNBs for the macro cells 102a, 102b and 102c, respectively. The eNB 110x is a pico eNB for a pico cell 102x. And, the eNBs 110y and 110z are femto eNBs for the femto cells 102y and 102z, respectively. An eNB may support one or multiple (e.g., two, three, four, and the like) cells.

The wireless network 100 also includes relay stations. A relay station is a station that receives a transmission of data and/or other information from an upstream station (e.g., an eNB, a UE, or the like) and sends a transmission of the data and/or other information to a downstream station (e.g., another UE, another eNB, or the like). A relay station may also be a UE that relays transmissions for other UEs. In the example shown in FIG. 1, a relay station 110r may communicate with the eNB 110a and a UE 120r, in which the relay station 110r acts as a relay between the two network elements (the eNB 110a and the UE 120r) in order to facilitate communication between them. A relay station may also be referred to as a relay eNB, a relay, and the like.

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

The UEs 120 are dispersed throughout the wireless network 100, and each UE may be stationary or mobile. A UE may also be referred to as a terminal, a mobile station, a subscriber unit, a station, or the like. A UE may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like. In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

LTE/-A utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, or the like. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, K may be equal to 128, 256, 512, 1024, 2048, or 4096 for a corresponding system bandwidth of 1.4, 3, 5, 10, 15, or 20 megahertz (MHz), respectively. The system bandwidth may also be partitioned into sub-bands. For example, a sub-band may cover 1.08 MHz, and there may be 1, 2, 4, 8 or 16 sub-bands for a corresponding system bandwidth of 1.4, 3, 5, 10, 15, or 20 MHz, respectively.

The wireless network 100 uses the diverse set of eNBs 110 (i.e., macro eNBs, pico eNBs, femto eNBs, and relays) to improve the spectral efficiency of the system per unit area. Because the wireless network 100 uses such different eNBs for its spectral coverage, it may also be referred to as a heterogeneous network. The macro eNBs 110a-c are usually carefully planned and placed by the provider of the wireless network 100. The macro eNBs 110a-c generally transmit at high power levels (e.g., 5 W-40 W). The pico eNB 110x and the relay station 110r, which generally transmit at substantially lower power levels (e.g., 100 mW-2 W), may be deployed in a relatively unplanned manner to eliminate coverage holes in the coverage area provided by the macro eNBs 110a-c and improve capacity in the hot spots. The femto eNBs 110y-z, which are typically deployed independently from the wireless network 100 may, nonetheless, be incorporated into the coverage area of the wireless network 100 either as a potential access point to the wireless network 100, if authorized by their administrator(s), or at least as an active and aware eNB that may communicate with the other eNBs 110 of the wireless network 100 to perform resource coordination and coordination of interference management. The femto eNBs 110y-z typically also transmit at substantially lower power levels (e.g., 100 mW-200 mW) than the macro eNBs 110a-c.

In operation of a heterogeneous network, such as the wireless network 100, each UE is usually served by the eNB 110 with the better signal quality, while the unwanted signals received from the other eNBs 110 are treated as interference. While such operational principals can lead to significantly sub-optimal performance, gains in network performance are realized in the wireless network 100 by using intelligent resource coordination among the eNBs 110, better server selection strategies, and more advanced techniques for efficient interference management.

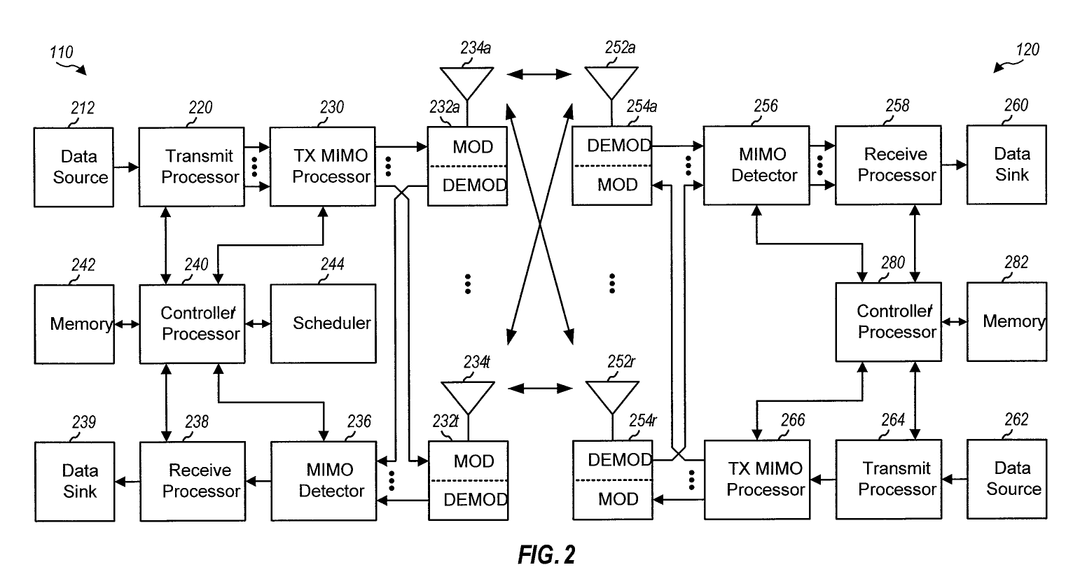

FIG. 2 shows a block diagram of a design of a base station/eNB 110 and a UE 120, which may be one of the base stations/eNBs and one of the UEs in FIG. 1. For a restricted association scenario, the eNB 110 may be the macro eNB 110c in FIG. 1, and the UE 120 may be the UE 120y. The eNB 110 may also be a base station of some other type. The eNB 110 may be equipped with antennas 234a through 234t, and the UE 120 may be equipped with antennas 252a through 252r.

At the eNB 110, a transmit processor 220 may receive data from a data source 212 and control information from a controller/processor 240. The control information may be for the physical broadcast channel (PBCH), physical control format indicator channel (PCFICH), physical hybrid automated repeat request channel (PHICH), physical downlink control channel (PDCCH), etc. The data may be for the physical downlink shared channel (PDSCH), etc. The transmit processor 220 may process (e.g., encode and symbol map) the data and control information to obtain data symbols and control symbols, respectively. The transmit processor 220 may also generate reference symbols, e.g., for the primary synchronization signal (PSS), secondary synchronization signal (SSS), and cell-specific reference signal or “common” reference signal (CRS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. Downlink signals from modulators 232a through 232t may be transmitted via the antennas 234a through 234t, respectively.

At the UE 120, the antennas 252a through 252r may receive the downlink signals from the eNB 110 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all the demodulators 254a through 254r, perform MIMO detection on the received symbols if applicable, and provide detected symbols. A receive processor 258 may process (e.g., demodulate, deinterleave, and decode) the detected symbols, provide decoded data for the UE 120 to a data sink 260, and provide decoded control information to a controller/processor 280.

On the uplink, at the UE 120, a transmit processor 264 may receive and process data (e.g., for the PUSCH) from a data source 262 and control information (e.g., for the PUCCH) from the controller/processor 280. The transmit processor 264 may also generate reference symbols for a reference signal. The symbols from the transmit processor 264 may be precoded by a TX MIMO processor 266 if applicable, further processed by the demodulators 254a through 254r (e.g., for SC-FDM, etc.), and transmitted to the eNB 110. At the eNB 110, the uplink signals from the UE 120 may be received by the antennas 234, processed by the modulators 232, detected by a MIMO detector 236 if applicable, and further processed by a receive processor 238 to obtain decoded data and control information sent by the UE 120. The processor 238 may provide the decoded data to a data sink 239 and the decoded control information to the controller/processor 240.

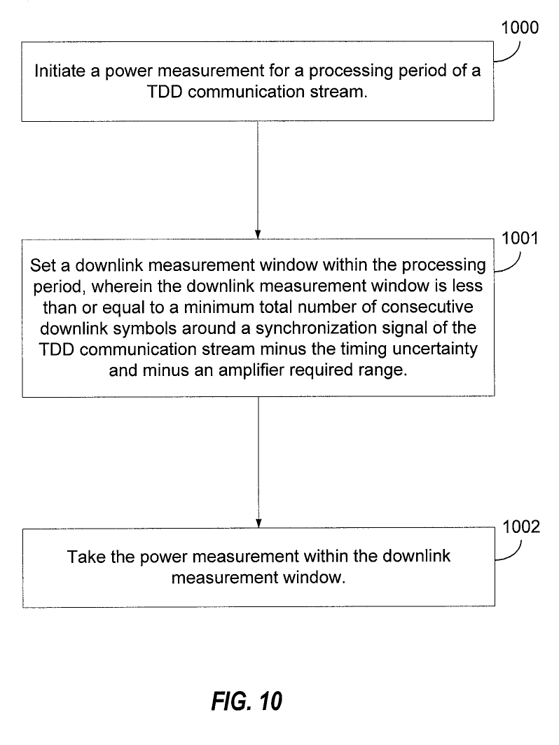

The controllers/processors 240 and 280 may direct the operation at the eNB 110 and the UE 120, respectively. The controller/processor 240 and/or other processors and modules at the eNB 110 may perform or direct the execution of various processes for the techniques described herein. The controllers/processor 280 and/or other processors and modules at the UE 120 may also perform or direct the execution of the functional blocks illustrated in FIGS. 10, 17, and 18, and/or other processes for the techniques described herein. The memories 242 and 282 may store data and program codes for the eNB 110 and the UE 120, respectively. A scheduler 244 may schedule UEs for data transmission on the downlink and/or uplink.

In LTE TDD systems, there are different uplink-downlink configurations, as shown in Table 1, that identify the downlink-to-uplink switch-point periodicity, as well as the number and location of uplink and downlink subframes within the radio frame. Table 1 illustrates the subframe position for uplink (U) subframes, downlink (D) subframes, and special (S) subframes.

TABLE 1

| | Downlink- | | | | | | | | | | |
|---|---|---|---|---|---|---|---|---|---|---|---|
| Uplink- | to-Uplink | | | | | | | | | | |
| downlink | Switch- | | | | | | | | | | |
| con- | point | Subframe number | | | | | | | | | |
| figuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

The configuration also determines how many symbols are used in the special subframes, as shown in Table 2, for DwPTS, guard period, and UpPTS in both normal cyclic prefix (CP) applications with 14 symbols available and extended CP with 12 symbols available.

TABLE 2

| | Normal CP | | | Extended CP | | |
|---|---|---|---|---|---|---|
| Configuration | DwPTS | GP | UpPTS | DwPTS | GP | UpPTS |
| 0 | 3 | 10 | 1 | 3 | 8 | 1 |
| 1 | 9 | 4 | 1 | 8 | 3 | 1 |
| 2 | 10 | 3 | 1 | 9 | 4 | 1 |
| 3 | 11 | 2 | 1 | 10 | 1 | 1 |
| 4 | 12 | 1 | 1 | 3 | 7 | 2 |
| 5 | 3 | 9 | 2 | 8 | 2 | 2 |
| 6 | 9 | 3 | 2 | 9 | 1 | 2 |
| 7 | 10 | 2 | 2 | — | — | — |
| 8 | 11 | 1 | 2 | — | — | — |

In each uplink/downlink configuration, the first subframe of the radio frame is a downlink subframe. A typical subframe, such as DL Subframe #0, includes 14 downlink symbols. Each configuration is then followed by a special subframe, such as Special Subframe #1. Within each special subframe, the first set of symbols are also the downlink symbols in the DwPTS 304. The number of such downlink symbols in DwPTS 304 is determined by the configuration. In the majority of configurations (except configurations 0 and 5), there are at least 9 downlink symbols in the DwPTS 304. Accordingly, in most configurations, there are a minimum of 23 downlink symbols available in which to obtain a signal power measurement of the signal coming into the antenna. The signal power measurement may be determined over a certain time window and sampling bandwidth for the signal coming into the antenna. This signal power measurement over the time window and sampling bandwidth for the signals coming into the antenna may be referred to as the broadband energy estimate (BBEE) or simply the signal power measurement.

Because timing information is not known by the UE, there is a timing uncertainty of a tick duration for making BBEE or signal power measurements. Unless specified otherwise, a tick duration will be noted as 1 ms, although in practice the tick duration may be other times, such as 0.5 ms, and the like. Moreover, the timing uncertainty reflects the available rate of measurement and gain application. Thus, the 1 ms timing uncertainty would mean that only one BBEE or signal power measurement may be made per 1 ms and, similarly, an amplifier gain may only be set once per 1 ms. While 1 ms may be used in examples described herein for timing uncertainty, actual timing uncertainty may be various times, such as 1 ms, 0.5 ms, and the like. The BBEE or signal power measurement itself takes a finite amount of time hence referred to as the measurement window. A longer measurement window would typically signify a better measurement quality.

For effective downlink processing, the correct amplifier gain should be set in a receiver during the various modes of operation. For example, in frequency scan (FSCAN) mode, the receiver should guarantee that all subframes are processed with the correct amplifier gain setting. Other modes include acquisition mode and inter-technology switching (X2L) idle and connected modes. These modes generally have multiple parts or stages, such as a searching stage, in which the receiver should guarantee the correct amplifier gain state for PSS and SSS symbols, and a measurement stage, in which the receiver should guarantee that the reference signals (RS) symbols are processed with the correct amplifier gain state.

It should be noted that various aspects of the present disclosure may include different types of amplifiers, such as variable gain amplifiers (VGAs), programmable gain amplifiers (PGAs), each including low noise amplifiers (LNAs), very low noise amplifiers (VLNAs), and the like.

The automatic gain control (AGC) functionality of a receiver controls the amplifier gain settings based on a BBEE/signal power measurement of the symbol stream. In order to select the correct amplifier gain, the BBEE, upon which the amplifier gain is based, should be measured on downlink transmissions or symbols. However, there are some operational modes in which the receiver does not generally know the frame timing. Thus, the UE may not be able to accurately align its BBEE measurement process to only the downlink subframes. One method to effectively control the BBEE measurements and ensure that the appropriate downlink BBEE measurement will be applied is through pipeline processing of the AGC.

In pipeline AGC processing, the symbol stream is divided into individual time blocks (length Tₚ) that correspond to one processing unit (also referred to as a “tick”). Within a given radio frame there will be a number of different time “pipes” or individual time blocks, in which the next time block for a given time pipe will be located in the next radio frame in a time division processing manner. The number of such time pipes that are being tracked per radio frame is represented by Lₚᵢₚₑₗᵢₙₑ. Therefore, there is a periodicity element to pipeline AGC processing. This periodicity may be used with the periodicity inherent in the uplink/downlink periodicity, such as 5 or 10 ms, as the case may be.

In selected aspects considering the inherent periodicity in the acquisition and X2L modes (5 ms) and the periodicity inherent in the FSCAN mode (10 ms) to more accurately ensure that the BBEE measurements for the amplifier gain states applied to the guaranteed symbols are measured from downlink symbols.

In FSCAN mode, the pipeline AGC processing should satisfy the equation:

Tₚ*Lₚᵢₚₑₗᵢₙₑ=10 ms (1)

For acquisition and the X2L modes, the pipeline AGC processing for both the searching and measurement stages should satisfy the equation:

Tₚ*Lₚᵢₚₑₗᵢₙₑ=5 ms (2)

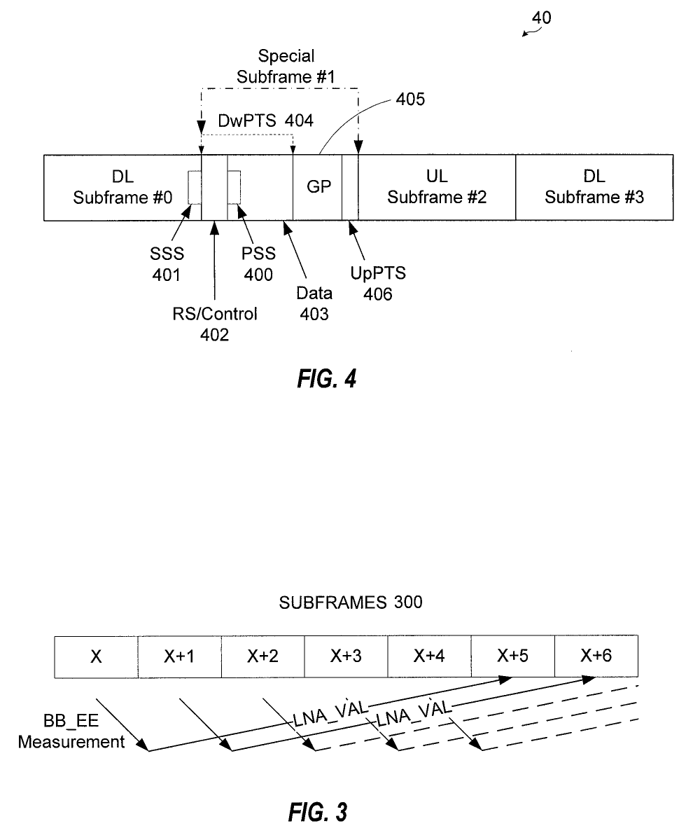

In general, due to the periodicity of transmissions, a BBEE measurement will be used to set the amplifier gain 5 ms after the BBEE measurement. FIG. 3 is a block diagram illustrating subframes 300 of a communication stream. A BBEE measurement at subframe X will control the amplifier gain setting for subframe X+5, where, as illustrated, the 5 represents milliseconds. Similarly, the BBEE measurement at subframe X+1 controls the amplifier gain setting for subframe X+6 and so on. The particular amplifier gain setting corresponding to the BBEE measurements are stored on the UE and, after an initial acquisition stage, the UE will begin to repeat the stored amplifier gain settings for future corresponding subframes.

The pipeline AGC processing may further be configured to take advantage of the continuous downlink symbols located in subframe 0 and the DwPTS. FIG. 4 is a block diagram illustrating a communication stream 40. The communication stream 40 is divided into multiple subframes, DL Subframe #0, Special Subframe #1, UL Subframe #2, and DL Subframe #3. The Special Subframe #1 includes both uplink and downlink symbols as well as a guard period (GP) 405. Special Subframe #1 includes RS/Control symbols 402, PSS 400, data symbols 403, and uplink pilot time slot (UpPTS) 406. The combination of RS/control 402, PSS 400, and data symbols 403 comprise the downlink pilot time slot (DwPTS) 404.

In selected aspects of the present disclosure, the pipeline AGC processing takes advantage of the contiguous downlink symbols in locations relative to known synchronization signals, such as, in LTE systems, before and after PSS and SSS, and shrinks (and maximizes) the measurement window to ensure there is at least one BBEE/signal power measurement that is done entirely within a downlink. In such selected aspects of the present disclosure, the measurement window is shrunk just enough to satisfy the following equation:

Measurement Window+Timing Uncertainty+LNA Req. Range≦Minimum DL (3)

Where LNA Req. Range (or observation window) represents the period during which the amplifier gain is to be set based on the BBEE measured during a downlink. For Acquisition mode in LTE systems, this period may be between the start of the SSS and the end of the PSS, such as 4 symbols. In the Acquisition mode example, for the configurations with at least 9 or more downlink symbols in DwPTS, which implies that there are 23 consecutive downlink symbols with 14 symbols per 1 ms subframe, the timing uncertainty may be set to 1 ms (=14 symbols), where the measurement window will be less than or equal to the minimum total number of consecutive downlink symbols minus the timing uncertainty minus the LNA required range/observation window (e.g., 4 symbols) or the measurement window will be less than or equal to 5 symbols (23−14−4=5 symbols). Since the relative time offset between the known continuous downlink symbols and synchronization signals, such as PSS and SSS in LTE, is known, the amplifier gain should be set with a time offset that is relative to the BBEE measurement such that for both PSS and SSS, on the BBEE measured during a downlink transmission is used. This time offset may be such that it takes advantage of the periodicity of synchronization signals, such as PSS and SSS in LTE, or other patterns.

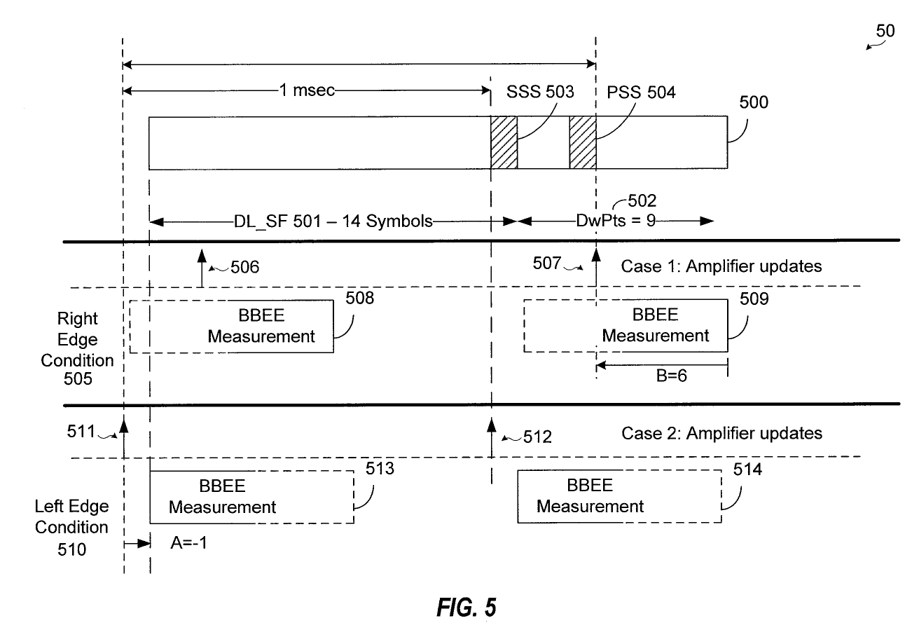

FIG. 5 is a timing diagram 50 illustrating BBEE measurement timing for pipeline AGC processing configured according to one aspect of the present disclosure. Communication stream 500 illustrates a downlink subframe 501, having 14 symbols and ending with SSS 503, and the DwPTS 502 of the special subframe having 9 symbols, including PSS 504. In order to establish the appropriate measurement window, the measurement processing may be examined at the extreme processing conditions represented in the right edge condition 505 and left edge condition 510.

It should be noted that the example aspects described and illustrated for the right edge condition 505 and left edge condition 510 are based on normal CP configurations. However, a parallel method may be adapted and used for right and left edge conditions based on extended CP configurations.

Right edge condition 505 represents the amplifier updates 506 and 507 occurring at the extreme right edge, which is present when the amplifier update 507 occurs at the right edge of PSS 504. The preceding amplifier update 506 occurs 1 ms prior to amplifier update 507, within the downlink subframe 501. In order to ensure that there will be at least one good downlink measurement with the BBEE 509, BBEE 509 should not be scheduled during any uplink symbols. Thus, BBEE 509 should end at the boundary of the DwPTS 502 of communication stream 500.

In this right edge condition 505, the UE would know when amplifier update 507 occurs. Therefore, as long as a relative phase is maintained between BBEE 509 and the amplifier update 507, the UE may ensure that BBEE 509 does not include uplink symbols. Thus, the ending boundary ‘B’ for the measurement window of BBEE 509 would be 6 symbols after the amplifier update 507. Boundary ‘B’ of the right edge condition 505 provides the right-most edge of the measurement window.

Left edge condition 510 represents the amplifier updates 511 and 512 occurring at the extreme left edge, which is present when the amplifier update 512 occurs at the left edge of the SSS 503. The previous amplifier update 511 occurs 1 ms prior to amplifier update 512, beginning in the subframe before the downlink subframe 501. Because the subframe preceding the downlink subframe 501 is not guaranteed to be downlink symbols, the BBEE 513 should begin 1 symbol after the amplifier update 511. Boundary ‘A’ for the left side boundary of the measurement window would be −1 symbol (the negative indicating that the start-boundary of the measurement window is to the right of amplifier update 511. Thus, in order to ensure that there will be at least one good downlink measurement with BBEE 513, BBEE 513 should be scheduled to begin at least 1 symbol to the right of amplifier update 511. As with the boundary ‘B’, the UE knows when amplifier update 511 occurs. Therefore, the relative phase of the beginning boundary ‘A’ is maintained between BBEE 513 and amplifier update 511.

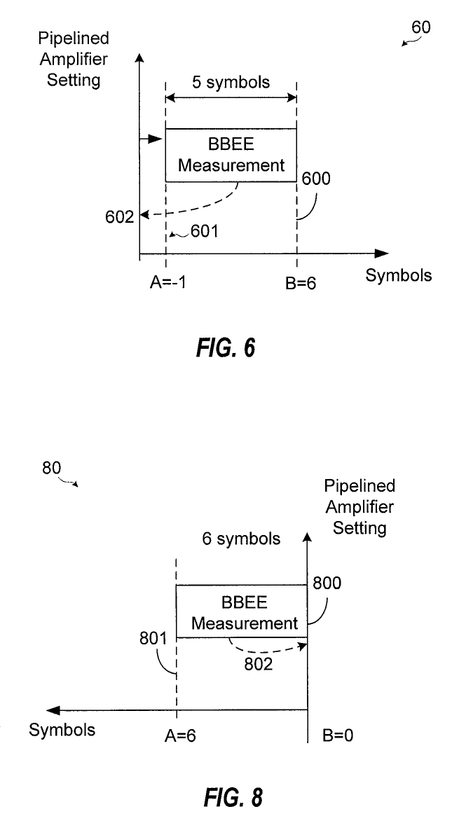

FIG. 6 is a diagram illustrating the BBEE measurement window 60 configured according to one aspect of the present disclosure. In considering the right edge condition 505 (FIG. 5) and left edge condition 510 (FIG. 5) to set the boundaries of the BBEE measurement window 60, the diagram illustrates the BBEE measurement beginning 1 symbol 601 (A=−1) after the amplifier pipeline setting and ending no more than 6 symbols 600 (B=6) after the amplifier pipeline setting. This BBEE measurement window 60 maintains a relative phase 602 with the amplifier pipeline setting. The resulting BBEE measurement window 60, thus, satisfies Equation 3 for the majority of uplink/downlink configurations having at least 9 symbols in the DwPTS and a measurement timing uncertainty of 1 ms by having a window of 5 symbols or less. Therefore, if the UE schedules a BBEE measurement within BBEE measurement window 60, it should ensure at least one downlink measurement.

It should be noted that, the duration of the BBEE/signal power measurement, T_{BBEE}, should also be set to a long enough period to ensure that such a downlink symbol, such as a CRS, is measured. In normal CP configurations, CRS occur at symbols 0, 4, 7, and 11. Therefore, the minimum T_{BBEE} for normal CP configurations should be 4/14 ms (if measurement began at symbol 1, a BBEE of 4 symbols would be needed to measure the CRS at symbol 4—thus 4/14 ms). In contrast, extended CP configurations transmit the CRS at symbols 0, 3, 6, and 9. Therefore, the minimum T_{BBEE} for extended CP configurations should be 3/12 ms (if measurement began at symbol 1, a BBEE of 3 symbols would be needed to measure the CRS at symbol 3—thus 3/12 ms). In order to ensure measuring at least one downlink symbol over either normal or extended CP, the T_{BBEE} should be selected as 4/14 ms. Therefore, a BBEE measurement of 4/14 ms (or 4 symbols long in normal CP) would fit within the BBEE measurement window 60 and ensure that at least one downlink symbol is measured.

With reference to Table 2, configurations 0 and 5 provide for a DwPTS of only 3 symbols. Thus, in an implementation of such configurations, there are only 17 minimum downlink symbols between the first subframe and the DwPTS of the special subframe. These configurations cause the optimal measurement window equation, Equation (3), to fail, assuming that timing uncertainty is still 1 ms. The measurement window would need to be less than or equal to the minimum downlink symbols (now at 17 symbols) minus the timing uncertainty (1 ms or 14 symbols) minus the LNA required range/observation window (4 symbols). Already, using the new configuration conditions, Equation (3) fails, as the measurement window cannot be 0 symbols or less.

In another aspect of the present disclosure, the pipeline AGC processing is modified to reduce the timing uncertainty to 0.5 ms instead of 1 ms. By reducing the timing uncertainty, Equation (3) results in a valid result when dealing with DwPTS configurations of 3 symbols. The measurement window is less than or equal to the minimum download symbols (17 symbols) minutes the timing uncertainty (0.5 ms or 7 symbols) minus the LNA required range (4 symbols). With this modified implementation, the measurement window would be equal to or less than 6 symbols.

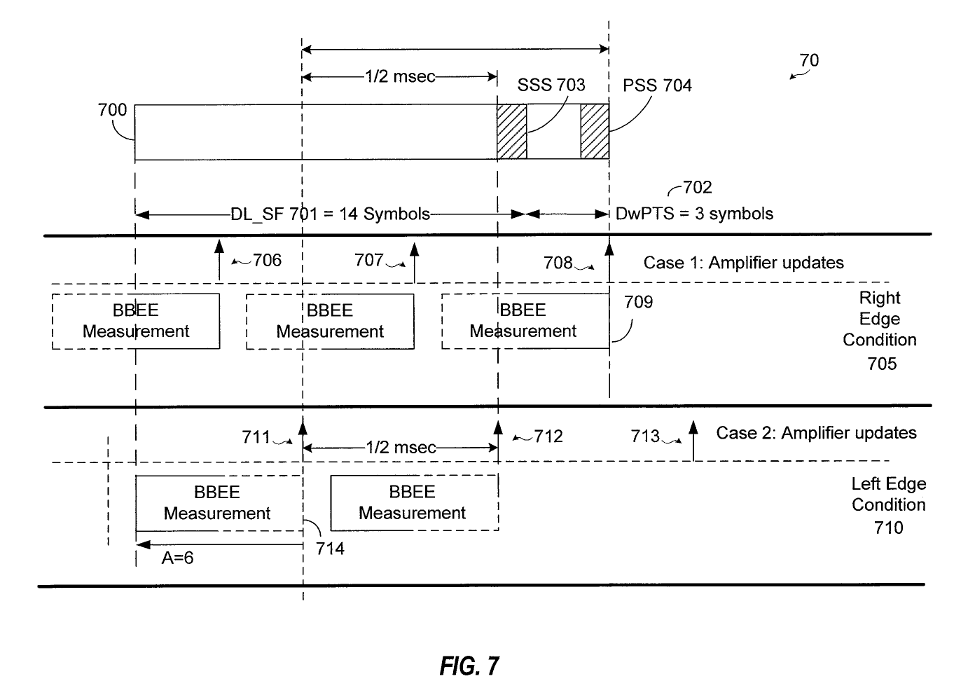

FIG. 7 is a timing diagram 70 illustrating BBEE measurement timing for pipeline AGC processing configured according to one aspect of the present disclosure. Communication stream 700 includes a downlink subframe 701 with 14 symbols, and a DwPTS 702 having 3 symbols, including SSS 703 and PSS 704. As previously indicated, in order to establish the appropriate measurement window, the measurement processing may be examined at the extreme processing conditions represented in the right edge condition 705 and left edge condition 710.

Right edge condition 705 represents the amplifier updates 706-708, with amplifier update 708 occurring at the extreme right edge, which is present when the amplifier update 708 occurs at the right edge of PSS 704. In order to ensure that there will be at least one good downlink measurement with the BBEE 709, BBEE 709 should not be scheduled during any uplink symbols. Thus, BBEE 709 should end at the boundary of the DwPTS 702 of communication stream 700. Accordingly, BBEE 709 ends at the right edge of PSS 704 and the amplifier update 708, such that the boundary ‘B’ is 0.

Left edge condition 710 represents the amplifier updates 711-713 occurring at the extreme left edge, which is present when the amplifier update 712 occurs at the left edge of the SSS 703. Because the subframe preceding the downlink subframe 701 is not guaranteed to be downlink symbols, the BBEE 714 should begin at the left edge of the downlink subframe 701. At this location, the beginning of BBEE 714 occurs 6 symbols before the amplifier update 711. Boundary ‘A’ for the left side boundary of the measurement window would be 6 symbols. Thus, in order to ensure that there will be at least one good downlink measurement with BBEE 714, BBEE 714 should be scheduled to begin at least 6 symbols before amplifier update 711.

FIG. 8 is a diagram illustrating the BBEE measurement window 80 configured according to one aspect of the present disclosure. In considering the right edge condition 705 (FIG. 7) and left edge condition 710 (FIG. 7) to set the boundaries of the BBEE measurement window 80, the diagram illustrates the BBEE measurement beginning 6 symbols 801 (A=6) before the amplifier pipeline setting 800 and ending at the amplifier pipeline setting 800 (B=0) after the amplifier pipeline setting. The resulting BBEE measurement window 80 indicates a causal relationship 802 of the amplifier pipeling setting 800 with respect to the measurement. The resulting BBEE measurement window 80, thus, satisfies Equation (3) for the uplink/downlink configurations having 3 symbols in the DwPTS and a measurement timing uncertainty of 0.5 ms by having a window of 6 symbols or less. Therefore, if the UE schedules a BBEE measurement within BBEE measurement window 80, it should ensure at least one downlink measurement.

It should be noted that, while a causal relationship exists between the amplifier pipeline setting and BBEE measurement, practical considerations reflect that an amplifier gain setting cannot immediately be applied after the BBEE measurement. Accordingly, the pipeline processing is used to apply an amplifier gain based on a BBEE measurement according to the current periodicity.

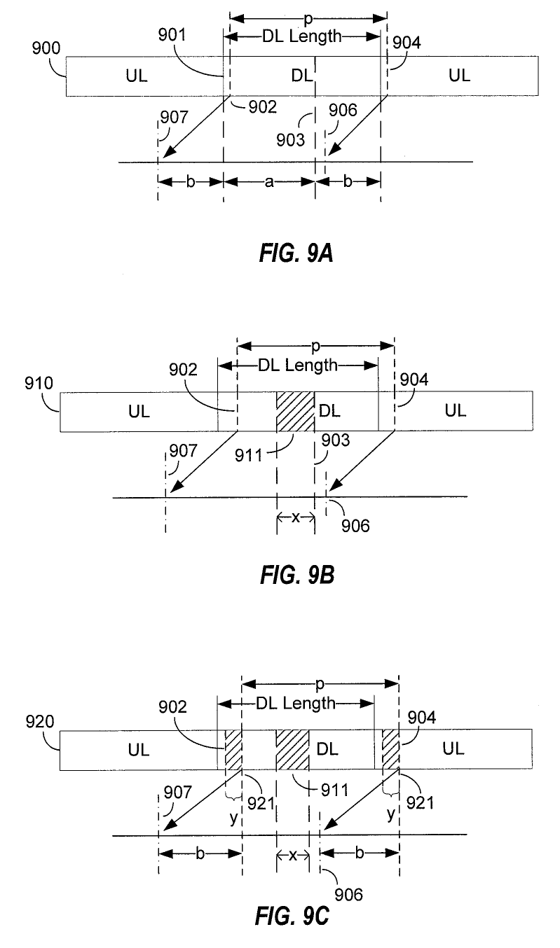

In an alternative aspect for determining a measurement window, consideration is made to various communication systems including non-LTE TDD systems. FIG. 9A is a block diagram illustrating a portion of transmission stream 900 illustrating multiple subframes including downlink subframe 901. As noted, in order to obtain an accurate measurement for an AGC application, the amplifier gain applied should be based on measurement of downlink transmissions or symbols. Thus, in order to produce an accurate amplifier gain, the measurement should be made during downlink subframe 901. Compatible TDD systems include synchronization signals at known times/locations within an observation window. For example, synchronization signals are known to occur at 903 within downlink subframe 901. Within downlink subframe 901, the synchronization signals at 903 are located within the observation window at a time/distance a from the front edge of downlink subframe 901 and a time/distance b from the back edge of downlink subframe 901.

For purposes of explanation, the system, for which transmission stream 900 is depicted in FIG. 9A, is hypothetically able to perform periodic measurement and use that measurement to set an amplifier gain for an observation, assuming a hypothetical, instantaneous measurement window periods at 902, 904 and an instant observation window where the synchronization signals lie, at 903. Accordingly, a power measurement is indicated during downlink subframe 901 at time instants 902, 904, separated by the time period p. For simplicity, other periodic recurrent measurements are not shown in the figure. The application of the amplifier gain, which should be b ahead of the power measurement, will occur at 906, 907. In actuality the system is causal, and since the TDD system is periodic, this application of amplifier gain can be made ahead of the next recurrence of the same DL subframe, such that the relative phase of the amplifier gain application appears to be b ahead of the power measurement, which happens in that subframe. In other words, the application of the amplifier gain occurs ahead of the measurement by the system period minus b. For simplicity, the application of amplifier gain will be shown at a time b ahead of the current measurement, without reference to the system period. The next power measurement is indicated at 904 (which is spaced from 902 by a ‘tick’ of time, p), which is then applied, with a relative phase ahead by b. Considering all time offsets of the power measurement (902 and 904) relative to the observation window (at 903), it can be seen that, in the case of the hypothetical instant measurement and observation, and a rate of measurement and amplifier gain application or tick duration, p, then, p length or amount of contiguous downlink symbols (DL Length=p) will be sufficient to obtain an accurate downlink power measurement for the amplifier gain application at 903 (which is set at instant 907), as long as the relative phase of the amplifier gain application is b ahead of the next measurement at 904.

FIG. 9B is a block diagram illustrating a portion of transmission stream 910 in which instant measurement is hypothetically possible while the instant observation 903 in FIG. 9A, is now replaced with a observation window 911 of finite length x, within which the synchronization signals lie. Because of observation window 911 is now at a finite length x, it can be seen that a length of p+x or greater of contiguous downlink symbols should be used, for all time offsets of power measurements at 902 and 904 relative to observation window 911, in order to obtain an accurate downlink measurement for amplifier gain application at 906, 907 for receiving the signal within observation window 911.

FIG. 9C is a block diagram illustrating a portion of the transmission stream 920 in which both measurement and observation occur over a finite period. The compatible systems of the example illustrated in FIG. 9C are less hypothetical, with measurement windows 902, 904 of y length and observation window 911 of x length, where the synchronization signals are contained. Thus, the amplifier gain application at 907, with relative phase b ahead of a right edge 921 of measurement window 902, will be effective during the reception of the synchronization signal contained in observation window 911. Considering all time offsets of measurement windows 902, 904 relative to observation window 911, in order for the amplifier gain application at 906, 907 to properly affect the reception of signals contained within observation window 911, the length of contiguous downlink symbols should be at least p+y+x, (DL Length=p+y+x) as illustrated in FIG. 9C. Further the application of the amplifier gain at 906, 907 should be relatively ahead of right edge 921 of measurement windows 902 and 904 by b. Therefore, in addition to the methods for determining a power measurement window described with respect to the example illustrated in FIG. 8, a power measurement window may be determined according to the formula described with respect to FIG. 9C.

FIG. 10 is a functional block diagram illustrating example blocks executed to implement one aspect of the present disclosure. In block 1000, a mobile device initiates a power measurement for a processing period, Tₚ, of a TDD communication stream. The processing period or tick is generally equal in length with the timing uncertainty of the pipeline AGC processing conditions. In response to the initiating, a downlink measurement window is set within the processing period, in block 1001, wherein the downlink measurement window is less than or equal to a minimum total number of consecutive downlink symbols around a synchronization signal of the TDD communication stream minus the timing uncertainty and minus a low noise amplifier (LNA) required range. For example, when the TDD uplink/downlink configuration is set such that DwPTS had 9 or more symbols, which implies that there are 23 consecutive downlink symbols with 14 symbols per 1 ms subframe, the timing uncertainty may be set to 1 ms (=14 symbols), where the measurement window will be less than or equal to the minimum total number of consecutive downlink symbols minus the timing uncertainty minus the LNA required range/observation window (e.g., 4 symbols) or the measurement window will be less than or equal to 5 symbols (23−14−4=5 symbols). When the TDD uplink/downlink configuration is set such that DwPTS has 3 symbols, which implies that here are 17 consecutive downlink symbols, the timing uncertainty may be set to 0.5 ms (=7 symbols), where the downlink measurement window will be less than or equal to the minimum total number of consecutive downlink symbols minus the timing uncertainty minus the LNA required range/observation window (e.g., 4 symbols) or the downlink measurement window is less than or equal to 6 symbols (17−7−4=6 symbols).

In block 1002, the mobile device takes the power measurement within the downlink measurement window.

According to additional aspects of the present disclosure, a unified pipeline AGC process may be applied for the different AGC modes (FSCAN, Acquisition, and X2L idle/connected modes). This unified pipeline AGC process is configured to work for all of the TDD cell configurations, including the configurations in which there are only 3 symbols in the DwPTS. As illustrated in FIG. 7, a timing uncertainty of 0.5 ms is used creating a 0.5 ms timing period, Tₚ, or tick. Thus, a power measurement will be made every 0.5 ms. The amplifier gain setting resulting from the power measurement will be applied in the tick that occurs 5.5 ms later. This processing sequence increases the likelihood that the amplifier gain setting applied to a guaranteed subframe, RS, PSS/SSS, or other such synchronization signals will be based on a power measurement of a downlink symbol.

Several processes occur for each time period, Tₚ, or tick. At the beginning of the tick, the amplifier gain setting is made. Depending on the stage of unified pipeline processing, this amplifier gain setting may be fixed for initial processing, may be freely updated based on current measurements and the location in a gain circular buffer (GCB) of the appropriate amplifier gain setting, or may be fixed based on the location in the GCB or received from the management layer. The GCB is a storage buffer used to record the amplifier gain settings for each of the time pipe states. As there are Lₚᵢₚₑₗᵢₙₑ time pipe states, the GCB will have Lₚᵢₚₑₗᵢₙₑ corresponding entries. Also, depending on the stage in processing, when an amplifier gain decision is made, the new amplifier gain setting may be stored to the GCB in relation to the current tick. A power measurement is also taken for each tick. This power measurement should be started at some time point, T_{BBEEOffset}, after the new amplifier gain setting has been applied.

In operation, the power measurement may start one symbol later than the application of the amplifier gain setting and stop before the beginning of the next tick. In normal CP configurations, one symbol represents 1/14 ms. Thus, the minimum T_{BBEEOffset} would be 1/14 ms for normal CP configurations. In extended CP configurations, one symbol represents 1/12 ms. Thus, the minimum T_{BBEEOffset} would be 1/12 ms for extended CP configurations. In order to create a unified approach, a T_{BBEEOffset} is set to 1/12 ms so that it may be successfully applied in either normal or extended CP configurations.

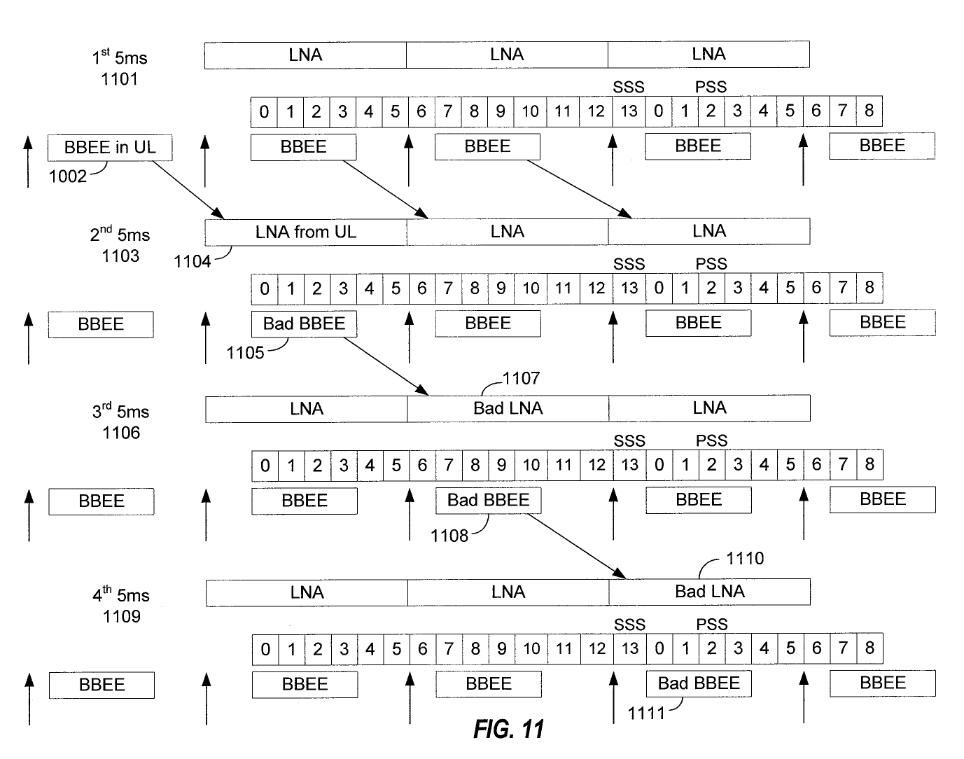

Using the 0.5 ms tick process, error propagation may still occur. However, because subsequent measurements would provide for measurement of at least one downlink symbol, the erroneous amplifier gain setting may be mitigated in subsequent 5 ms blocks. FIG. 11 is a timing diagram 1100 illustrating a pipeline AGC process configured according to one aspect of the present disclosure. The timing diagram 1100 illustrates four consecutive 5 ms transmission blocks. In the first 5 ms block 1101, BBEE measurement 1102 occurs in subframe before symbol 0. In the present example, the TDD cell configuration provides for an uplink subframe prior to the subframe beginning with symbol 0. Accordingly, the BBEE measurement 1102 will produce an incorrect amplifier gain setting 1104 applied to the first tick of the second 5 ms block 1103. In selected hardware configurations, because the incorrect amplifier gain setting 1104 is applied in the first tick of the second 5 ms block 1103, a corresponding bad BBEE measurement 1105 will be made from this tick. Again, the bad BBEE measurement 1105 may produce another corresponding incorrect amplifier gain setting 1107 in the second tick of the third 5 ms block 1106. However, because the bad BBEE measurement 1105 occurs over at least one downlink symbol over symbols 0-3 in the second 5 ms block 1103, the resulting amplifier gain setting 1107 may result in a better setting than the incorrect amplifier gain setting 1104 based on the uplink BBEE measurement 1102. Hence, by choosing an amplifier set which has a small number of amplifier gain stages while covering a larger dynamic range, we may alleviate the error propagation issue and guarantee the correct amplifier is used for the SSS and PSS.

The incorrect amplifier gain setting 1107 applied to symbols 6-12 of the third 5 ms block 1106 would cause another bad BBEE measurement 1108 in the second tick of the third 5 ms block. However, again, as the BBEE measurement 1108 occurs over at least one downlink symbol over symbols 7-10 in the third 5 ms block 1103, the resulting amplifier gain setting 1110 may result in a better setting than either or both of amplifier gain setting 1104 and 1107. Thus, bad BBEE measurement 1111 in the third tick of the fourth 5 ms block 1109 may, in fact, be close to the appropriate gain setting. Accordingly, while error propagation may still occur in the pipeline AGC process having a 0.5 ms tick size, the error should be mitigated as the process continues in further 5 ms blocks.

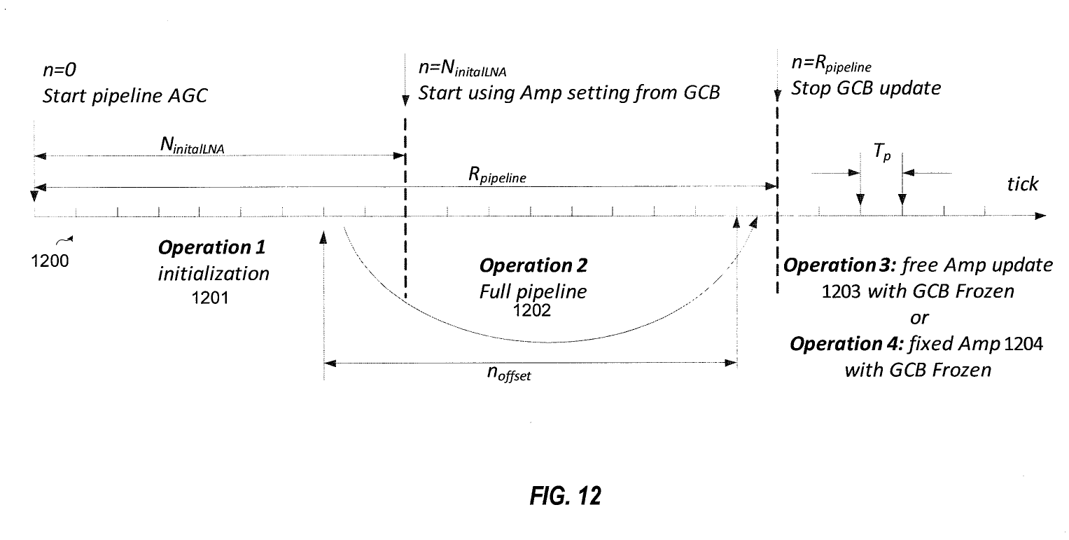

Using the 0.5 ms tick size, the unified pipeline AGC process may be divided into four operations. FIG. 12 is a timing diagram illustrating a communication stream 1200 configured for unified pipeline AGC processing according to one aspect of the present disclosure. Communication stream 1200 is divided into a number of ticks of a time period, Tₚ, in which n is the index of the tick. This first operation of unified pipeline AGC, initialization operation 1201, begins at n=0 and ends at n=N_{initialLNA}. N_{initialLNA} is the total number of ticks during initialization operation 1201 in which an initial default amplifier gain is used for processing in each tick. Thus, the amplifier gain is not updated from tick to tick. As the UE takes BBEE measurements during the ticks in initialization operation 1201, the amplifier gain derived based on the BBEE measurements are stored in the pipeline GCB. The initialization operation 1201 would be used during acquisition stages where the UE has not connected to a cell and does not yet have timing information.

The second operation of unified pipeline AGC, full pipeline operation 1202, begins at n=N_{initialLNA} and ends at n=Rₚᵢₚₑₗᵢₙₑ. Rₚᵢₚₑₗᵢₙₑ is the total number of ticks in which the GCB is accessed to store new or updated amplifier gain settings. The GCB is modified during both the initialization operation 1201 and the full pipeline operation 1202. Beginning at n=N_{initialLNA}, amplifier gain decisions are made for each tick in the full pipeline operation 1202. Amplifier gain settings are selected from the GCB based on an offset, n_{offset}. The amplifier gain applied to a current tick will be the amplifier gain decision stored in the GCB according to the GCB buffer position given by the equation:

GCB[mod(n−n_{offset},Lₚᵢₚₑₗᵢₙₑ)] (4)

BBEE measurements are made for each tick and an amplifier gain decision is made based on that measurement. The updated amplifier gain decision for each tick of the full pipeline operation 1202 is then saved to the GCB. Full pipeline operation 1202 is used during the FSCAN mode of operation.

After n=Rₚᵢₚₑₗᵢₙₑ, the GCB entries are no longer updated. Depending on the mode of operation, the unified pipeline AGC processing either performs a third operation, free amplifier update operation 1203, or a fourth operation, fixed amplifier operation 1204 after n=Rₚᵢₚₑₗᵢₙₑ. In each of free amplifier update operation 1203 and fixed amplifier operation 1204, the GCB is fixed. During free amplifier update operation 1203, the amplifier gain is updated in each tick. The amplifier gain applied during the tick is read from the GCB according to Equation (4). Free amplifier update operation 1203 is used for Acquisition and X2L Idle modes for the cell search parts of such modes. During fixed amplifier operation 1204 a fixed amplifier is applied across multiple ticks. Fixed amplifier operation 1204 is used for the measurement parts of Acquisition and X2L Idle modes.

It should be noted that the full pipeline operation 1202 may not be used in certain modes. In such modes, N_{initialLNA}=Rₚᵢₚₑₗᵢₙₑ and, after n=N_{initialLNA}, the UE would enter either one of free amplifier update operation 1203 or fixed amplifier operation 1204, depending on the particular mode of operation.

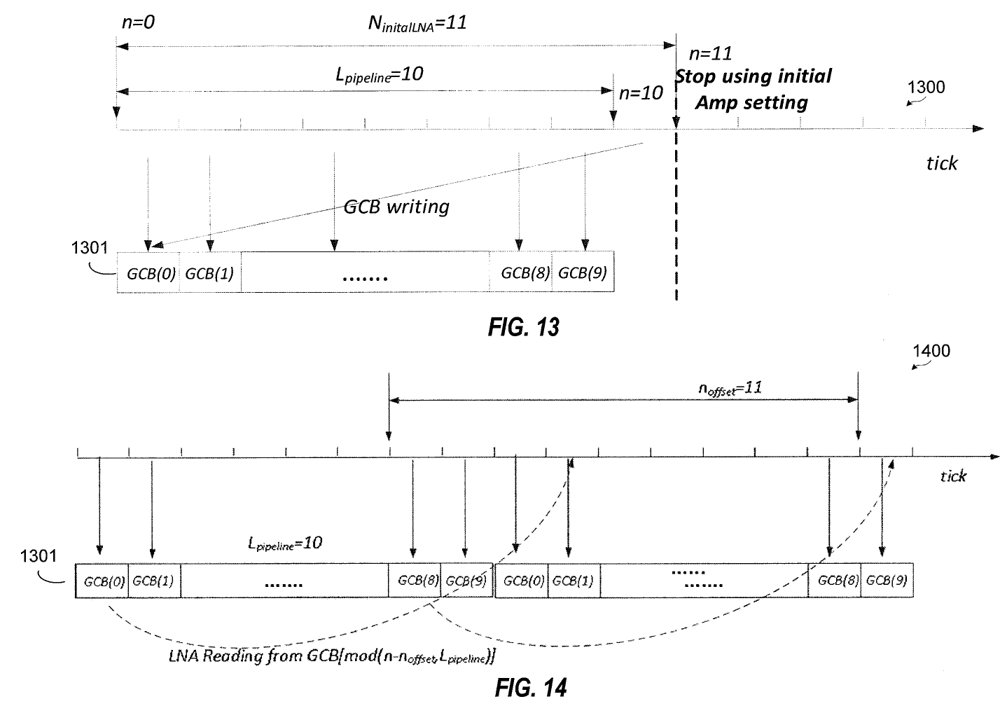

FIG. 13 is a timing diagram illustrating communication stream 1300 divided into ticks for unified pipeline AGC processing according to one aspect of the present disclosure. FIG. 13 illustrates the pipeline initialization operation of unified pipeline AGC processing. Processing of communication stream 1300 begins at n=0 in pipeline initialization operation. Initialization operations begin, for example, during the initial stages of all modes of operation. There are 10 time pipes being tracked for processing in communication stream 1300, such that Lₚᵢₚₑₗᵢₙₑ=10 and, thus, the length of GCB 1301 is also 10. During each tick from n=0 to N_{initialLNA}, an initial default amplifier gain is used. A BBEE measurement is also taken for each tick and an amplifier gain decision is made based on the BBEE measurement. This amplifier gain decision is written to a corresponding location in the GCB 1301 (e.g., GCB(0), GCB(1), and the like). In the illustrated example, N_{initialLNA} is set to 11. Therefore, the tick at n=10 is used to update the first entry of GCB 1301 at GCB(0).

FIG. 14 is a timing diagram illustrating communication stream 1400 divided into ticks for unified pipeline AGC processing according to one aspect of the present disclosure. FIG. 14 illustrates the full pipeline operation of unified pipeline AGC processing. Full pipeline operation processing of communication stream 1400 continuously updates the amplifier gain from tick to tick. BBEE measurements are taken in each tick and the new amplifier decision based on the BBEE measurement is written to the GCB 1301. With n_{offset}=11, the amplifier gain decision written to the GCB 1301 is applied according to Equation (4). For example, as illustrated, the amplifier gain decision written at GCB(0) of the first Lₚᵢₚₑₗᵢₙₑ set of ticks is used by the UE in the tick associated with GCB(1) of the next Lₚᵢₚₑₗᵢₙₑ set of ticks, while the amplifier gain decision written at GCB(8) of the first Lₚᵢₚₑₗᵢₙₑ set of ticks is used by the UE in the tick associated with GCB(9) of the next Lₚᵢₚₑₗᵢₙₑ set of ticks.

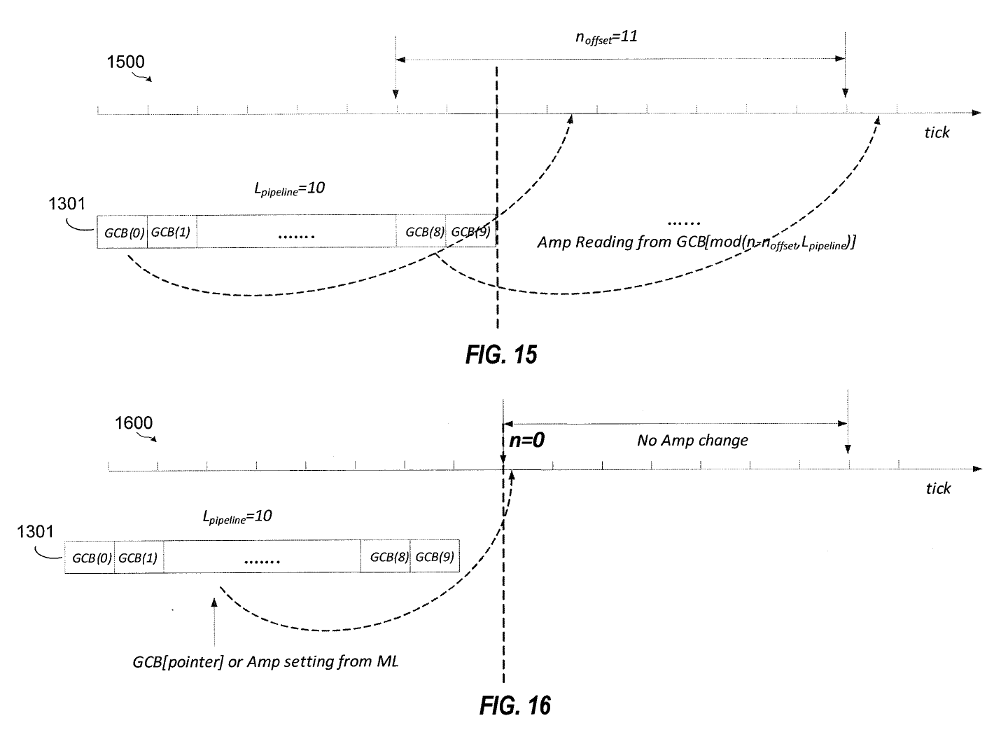

FIG. 15 is a timing diagram illustrating communication stream 1500 divided into ticks for unified pipeline AGC processing according to one aspect of the present disclosure. FIG. 15 illustrates the free amplifier update operation of the unified pipeline AGC processing. When n=Rₚᵢₚₑₗᵢₙₑ, free amplifier update operation begins, for example, during the cell search procedure in the Acquisition and X2L Idle modes. Entries to GCB 1201 are fixed, such that the UE no longer writes any new or updated amplifier gain decisions to the GCB 1301. However, amplifier gain states are updated during each tick from the GCB 1301 according to Equation (4), with n_{offset}=11 in the example illustrated in FIG. 15.

FIG. 16 is a timing diagram illustrating communication stream 1600 divided into ticks for unified pipeline AGC processing according to one aspect of the present disclosure. FIG. 16 illustrates the fixed amplifier operation that begins at n=Rₚᵢₚₑₗₘₑ during, for example, the measurement procedure in the Acquisition and X2L Idle modes. Entries to the GCB 1301 are fixed, as in the free amplifier update operation. However, in the fixed amplifier operation, the amplifier gain setting is also fixed over the processing period. The amplifier gain is either fixed as read from a particular entry to the GCB 1301 (e.g., GCB[pointer]) or may be assigned from the management layer of the UE.

The UE is configured to perform one or more of the four operations in a unified pipeline AGC process in response to the mode in which the UE is currently engaged for operation. In a Frequency Scan mode, for example, the UE's unified pipeline AGC operation would include the pipeline initialization operation and then the full pipeline operation. FSCAN has a periodicity of 10 ms, which allows it to have a larger pipeline than the other modes. In satisfying Equation (1), with a 0.5 ms time period, Tₚ, Lₚᵢₚₑₗᵢₙₑ for FSCAN is 20. FSCAN also provides for non-offset pipeline AGC processing with a time pipe. Thus, the n_{offset} for FSCAN is also 20, such that the amplifier gain setting written to GCB(0) of a first Lₚᵢₚₑₗᵢₙₑ set of ticks will be applied to the first tick corresponding to the GCB(0) location of the second Lₚᵢₚₑₗᵢₙₑ set of ticks.

A UE in the FSCAN mode begins at n=0 in the pipeline initialization operation. Thus, a fixed, initial amplifier gain is applied to each tick during the initialization process. A BBEE measurement is taken for each tick and the amplifier gain decision based on that BBEE measurement is written to the GCB of the corresponding location. At the tick corresponding to N_{initialLNA}=20, the UE shifts into the full pipeline operation. The amplifier gain decision written to the GCB satisfying Equation (4) is applied to each tick in the full pipeline operation, using the FSCAN n_{offset} of 20. The UE continues to make BBEE measurements in each tick and update the GCB with new amplifier gain decisions based on that measurement.

A UE in the Acquisition mode would include the pipeline initialization operation, the free amplifier update operation, and the fixed amplifier operation. A UE in the Acquisition mode begins at n=0 in the pipeline initialization operation. Thus, again, a fixed, initial amplifier gain is applied to each tick during the initialization process. A BBEE measurement is taken for each tick and the amplifier gain decision based on that BBEE measurement is written to the GCB of the corresponding location. At the tick corresponding to N_{initialLNA}=11, the UE shifts into the free amplifier update operation as the UE enters a cell search period. Pipeline AGC processing for Acquisition and X2L modes apply an offset for processing across different time pipes. Thus, N_{initialLNA} and n_{offset}=11.

During the cell search period of the Acquisition mode, the GCB is fixed. The UE will no longer write updated amplifier gain decisions to the GCB. However, the UE will update the amplifier gain setting for each tick during the free amplifier update operation according to Equation (4) using the Acquisition n_{offset} of 11. As the search results begin to arrive, the UE will start to decode the PBCH, causing the UE to shift into the fixed amplifier operation. In the fixed amplifier operation, the GCB remains fixed and the amplifier gain setting is fixed across each of the PBCH decoding ticks. The amplifier gain setting may be fixed according to a particular GCB entry or may be fixed by the management layer.

The Acquisition mode generally provides that the searching process will begin 1 ms after the GCB sample buffer is filled in the pipeline initialization operation. The amplifier gain, in the Acquisition mode, may also change with the PSS/SSS, causing some degradation.

A UE in the X2L Idle mode has two separate cases. In the first case, in which the management layer of the UE requests the firmware to begin from the search, the UE will operate in the pipeline initialization operation, the free amplifier update operation, and the fixed amplifier operation. The firmware receives a configuration application for acquisition and search procedures from the management layer and starts the pipeline initialization operation. The search part of the process may start at any time, even while in the pipeline initialization operation, when at least 1 ms of samples have been collected. The firmware will then send the search results, such as the peaks, signal-to-noise ratio (SNR), amplifier, and the like, to the management layer. The management layer will then send another configuration application for the measurement procedure along with the amplifier gain setting to the firmware, which updates the amplifier to this setting for the entire measurement.

It should be noted that a virtual cell (VCell) may be declared based on one of the search results per E-UTRA Absolute Radio Frequency Channel Number (EARFCN). The timing from this VCell may be used when measurements are performed without a previous search. In selected embodiments, the VCell timing may be based on the peak with the highest SNR in the SSS. Once declared, the VCell may be maintained per EARFCN.

In the second case, the management layer passes timing information to the firmware of the UE. The UE will operate in the pipeline initialization operation and the fixed amplifier operation. In this second case, the firmware receives only one configuration application for acquisition and measurement from the management layer. Upon receiving this configuration application and the timing information, the firmware begins the pipeline initialization operation, making amplifier gain decisions for X2L Idle mode measurement based on the timing information. The amplifier gain decisions are written to the GCB during the pipeline initialization operation. After the pipeline initialization operation, and the UE begins to perform measurements, the UE shifts to the fixed amplifier operation. The fixed amplifier applied by the UE during the measurements is assigned by the firmware layer.

In each of the available modes discussed, FSCAN, Acquisition, and X2L Idle, the UE accesses the same processes to perform the unified pipeline AGC processing depending on which process is active and what procedures are taking place within the active processes. The same processes are performed using different parameters selected according to the particular process. The parameters for the different available modes are provided in Table 3 below.

TABLE 3

| | | | X2L idle | |
|---|---|---|---|---|
| submode | FSCAN | ACQ | With timing | No timing |
| LNA initial Value | G2, G2 | G2, G2 | G2, G2 | G2, G2 |
| LNA input | | | | From ML for |
| | | | | measurement |
| LNA decision set | {G₀, G₂} | {G₀, G₂, G₃} | {G₀, G₂, G₃} | {G₀, G₂, G₃} |
| Lₚᵢₚₑₗᵢₙₑ | 20 | 10 | 10 | 10 |
| Rₚᵢₚₑₗᵢₙₑ | Until FSCAN | 11 | 11 | 11 |
| | stops | | | |
| N_{initalLNA} | 20 | 11 | 11 | 11 |
| n_{offset} | 20 | 11 | 11 | 11 |
| Tₚ | 0.5 ms | 0.5 ms | 0.5 ms | 0.5 ms |
| min (T_{BBEE}) | 2/7 ms | 2/7 ms | 2/7 ms | 2/7 ms |
| min (T_{BBEEoffset}) | | 1/12 ms | 1/12 ms | 1/12 ms |

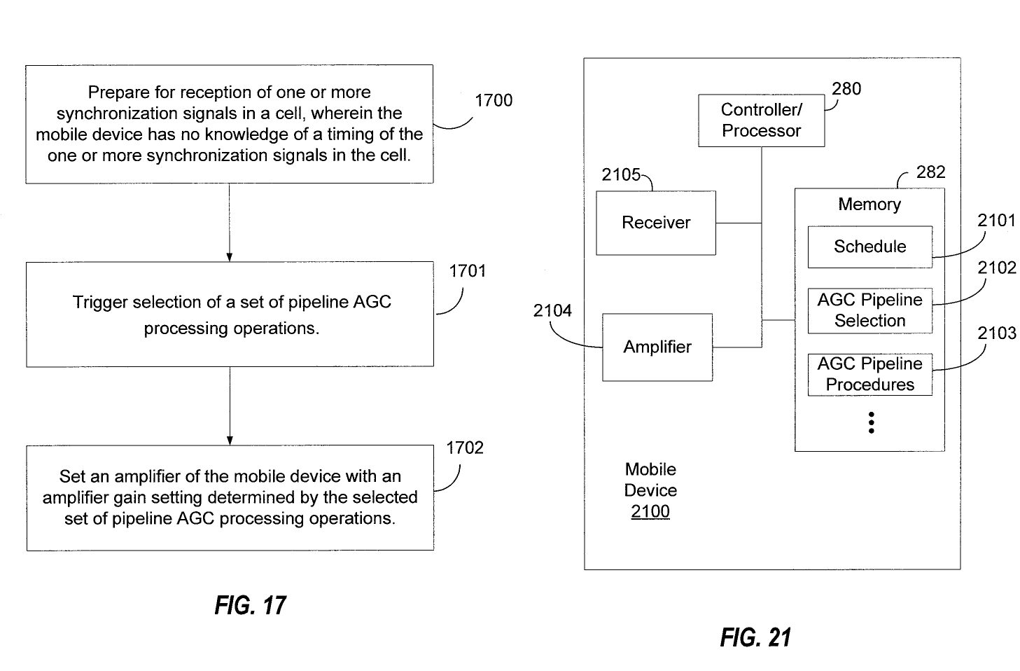

FIG. 17 is a functional block diagram illustrating example blocks executed to implement one aspect of the present disclosure. At block 1700, a mobile device prepares for reception of one or more synchronization signals in a cell, where the mobile device has no knowledge of a timing of the synchronization signals in the cell. In an example operation of the blocks illustrated in FIG. 17, a mobile device, such as mobile device 2100 (FIG. 21) may determine, under control of controller/processor 280 that synchronization signals may be scheduled for reception in a cell that mobile device 2100 does not know either or both of the timing or configuration of the signals or cell. Scheduling for various signals and network processes are maintained in schedule 2101 stored in memory 282. Controller/processor 280 may access schedule 2101 to determine such synchronization signals, which may include pilot signals, reference signals, or dedicated synchronization signals, such as PSS and SSS in LTE systems, may be received. The combination of these components and acts may provide means for preparing, by a mobile device, for reception of one or more synchronization signals in a cell, wherein the mobile device has no knowledge of a timing of the one or more synchronization signals in the cell.

At block 1701, the mobile device triggers selection of a set of pipeline AGC processing operations. Because the mobile device does not know either or both of the timing and configuration of the cell or the synchronization signals, it would execute the pipeline AGC process in order to determine an optimal amplifier gain setting for reception of such signals. With reference again to FIG. 21, in example operation, mobile device 2100, under control of controller/processor 280, executes AGC pipeline selection logic 2102, stored in memory 282. The executing environment of AGC pipeline selection logic 2102, will analyze the current mode of mobile device 2100 and select the appropriate set of AGC pipeline operations from multiple available AGC pipeline processing operations stored in AGC pipeline procedures 2103 in memory 282. Once selected, controller/processor 280 will execute the selected procedures from AGC pipeline procedures 2103 in order to determine the optimal amplifier gain setting under the current mode of operation. The combination of these components and acts may provide means for triggering, by the mobile device, selection of a set of pipeline AGC processing operations.

At block 1702, the mobile device sets an amplifier of the mobile device with an amplifier gain setting determined by the selected set of pipeline AGC processing operations. With the optimal amplifier gain setting determined by the pipeline AGC processes executed, the mobile device may set the amplifier according to this optimal gain to receive the expected synchronization signals. With reference again to FIG. 21, in example operation, the executing pipeline AGC processing operations from AGC pipeline procedures 2103 result in an optimal amplifier gain setting, under control of controller/processor 280. Controller/processor 280 then uses this optimal setting to set amplifier 2104 to the appropriate gain level. Thereafter, the synchronization signals that are received through receiver 2105 will be received using the optimal gain from amplifier 2104. The combination of these components and acts may provide means for setting, by the mobile device, an amplifier of the mobile device with an amplifier gain setting determined by the selected set of pipeline AGC processing operations.

When the selection of the pipeline AGC processing operations is triggered, the mobile device determines a mode of its operation. The mobile device selects a set of pipeline AGC processing operations from multiple available pipeline AGC processing operations. The mobile device selects the set based on the determined mode of operation. The multiple available pipeline AGC processing operations include a pipeline initialization operation, a full pipeline operation, a free amplifier update operation, and a fixed amplifier operation. The mobile determines a current function within the determined mode of operation and then performs one of the selected set of pipeline AGC processing operations, wherein the AGC operation performed is associated with the determined current function of the mobile device.

In the X2L Connected mode, the UE is connected to the communication network and may not have much time to tune away to interact with the different technology. The unified pipeline AGC processing would occur during the scheduled gaps. In X2L Connected mode, the GCB length is 10 (Lₚᵢₚₑₗᵢₙₑ=10). An offset is used to update the pipeline AGC. Each of the scheduled gaps are approximately 6 ms long. Essentially 1 ms is used for radio frequency front-end (RFFE) configuration. In selected aspects, the maximum time for pipeline initialization is 5.1 ms. In FDD operations, 2 ms will be wasted before obtaining the first BBEE reading. TDD operations are also challenging as all 5.1 ms should be fully used. The last BBEE reading would be close to the end of the gap, but is possible to be completed and used to make an amplifier gain decision.

It should be noted that one issue that may arise in gap processing in X2L Connected mode is the gap offset between consecutive ticks. Another issue that may arise concerns the time between any two gaps, which might be too long to perform meaningful AGC processing.

There are three types of gaps in the X2L Connected mode. The AGC (A) gap is used for pipeline AGC initialization. During this pipeline initialization operation a default amplifier gain setting is used while the UE performs BBEE measurements during each tick to make amplifier gain decisions and store those into the GCB. For example, the default amplifier gain setting may be set for the G0 gain level, while the amplifier gain decisions are made with the set of gain levels G0, G2, and G3. The tick timing for each group will re-initialize.

The AGC+searcher (AS) gap is a searcher-dedicated gap. The amplifier gain is updated in each tick with the UE performing the free amplifier update operation. With the amplifier gain settings updating from tick to tick, error propagations may occur. Amplifier gain decisions are made over a given set of gain levels, such as the set G0, G2, and G3. As noted previously, error propagation may be alleviated by selecting an amplifier set with a small number of amplifier gain stages.

The AGC+measurement+searcher (AMS) gap is a measurement-dedicated gap. The amplifier gain is fixed over the entire gap with the UE performing the fixed amplifier operation. In the AMS gap, the amplifier gain decisions are made over another set of gain levels, such as G0, G1, G2, and G3. The AMS gap will still schedule a searcher for operation during the gap.

In operation during each of the gap-types, a searcher is scheduled. The management layer will also send a GCB (MGCB) to the firmware along with the configuration application for each gap. The firmware will apply the amplifier gain setting from the MGCB continuously at the beginning of each tick and perform BBEE measurements for each tick. Amplifier gain decisions based on the BBEE measurements are written to local firmware pipeline circular buffer (FGCB). The firmware reports the FGCB to the management layer before exiting the gap.

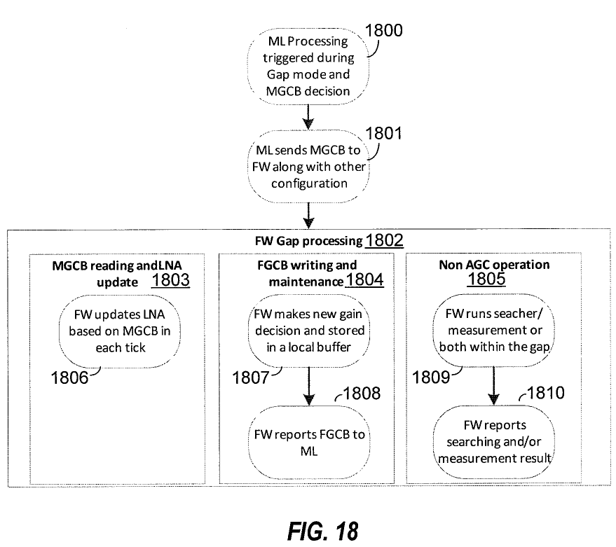

FIG. 18 is a functional block diagram illustrating example blocks executed to implement one aspect of the present disclosure. In block 1800, the management layer of the UE triggers gap processing during a gap mode with MGCB decisions. In response to triggering the gap processing, in block 1801, the management layer sends the MGCB to the firmware along with other configuration application information. Firmware gap processing operates, in block 1802, with three main processing blocks: MGCB reading and amplifier update block 1803, FGCB writing and maintenance block 1804, and non-AGC operation block 1805.

In the MGCB reading and amplifier update block 1803, the firmware updates the amplifier gain settings, in block 1806, based on the MGCB entries in each tick. In the FGCB writing and maintenance block 1804, the firmware makes new gain decisions and stores those new gain decisions in the FGCB local buffer in block 1807. In block 1808, the firmware reports the contents of the FGCB to the management layer. During the non-AGC operation block 1805, the firmware runs, in block 1805, a searcher operation, a measurement operation, or both within the gap. The firmware then reports, in block 1806, the searching and/or measurement results. This generic AGC operation will occur in each gap.

The gaps scheduled during the X2L Connected mode may be aligned in time or may have a timing offset. The timing relationship between consecutive gaps may have an impact on the application of amplifier gain settings from the MGCB and on BBEE/signal power measurements. The timing relationship between consecutive gaps may be determined based on the following equation:

(tₙ−tₙ₋₁)/0.5 ms=integer (6)

Where tₙ is the timing of the tick n and tₙ₋₁ is the timing of the tick n−1. If Equation (6) is satisfied with the result being an integer, then the consecutive gaps do not have a timing offset.

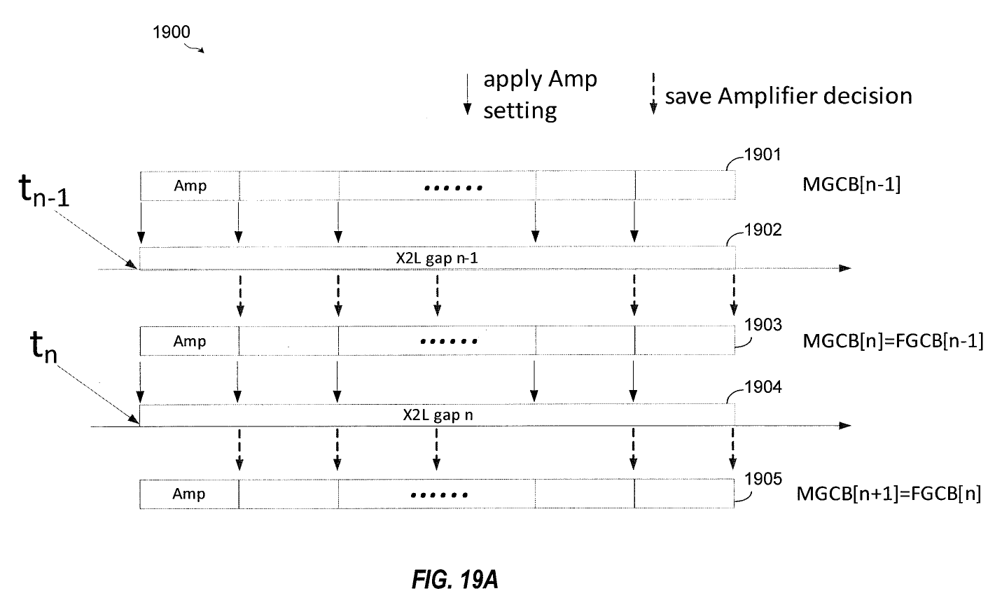

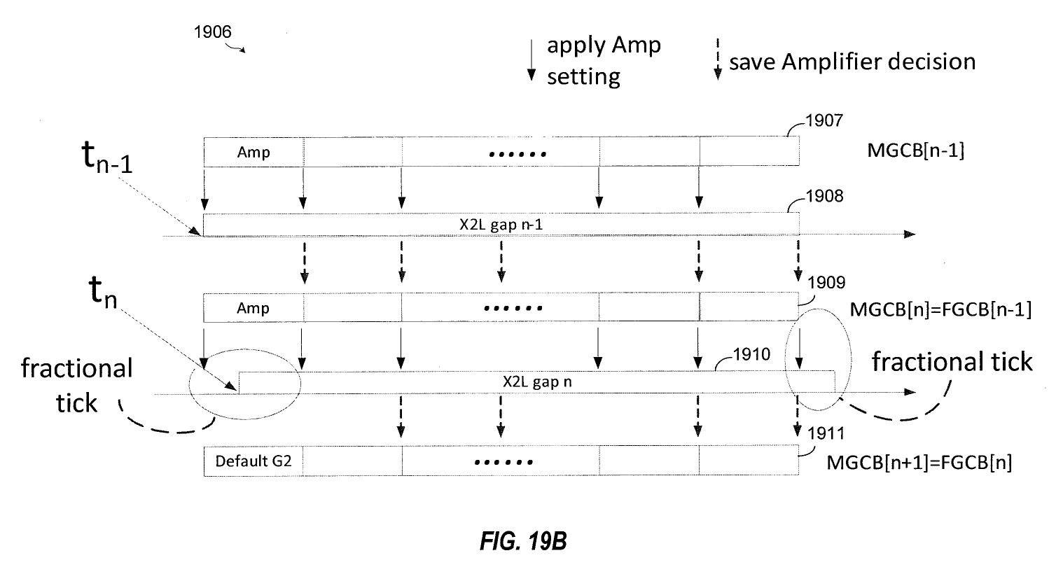

FIG. 19A is timing diagram 1900 illustrating pipeline AGC processing according to one aspect of the present disclosure. The amplifier settings from MGCB[n−1] 1901 are applied during gap 1902. Updated amplifier gain decisions based on BBEE/signal power measurements taken during gap 1902 are written to MGCB[n] 1903, which equals FGCB[n−1]. The corresponding amplifier settings from MGCB[n] 1903 are applied during gap 1904. Updated amplifier gain decisions based on BBEE measurements taken during gap 1904 are written to MGCB[n+1] 1905, which equals FGCG[n]. As illustrated in FIG. 19A, the timing of gap 1902 is aligned with the timing of gap 1904. Equation (6) is satisfied, yielding an integer result. Thus, the amplifier from the MGCB 1901 and 1903 are applied during each tick for 10 amplifier updates. The BBEE may also be scheduled in each tick for 10 updated amplifier gain decisions.

FIG. 19B is a timing diagram 1906 illustrating additional pipeline AGC processing according to one aspect of the present disclosure. The amplifier settings from MGCB[n−1] 1907 are applied during gap 1908. Updated amplifier gain decisions based on BBEE measurements taken during gap 1908 are written to MGCB[n] 1909, which equals FGCB[n−1]. There is a slight timing mismatch between gap 1910 and gap 1908. The result of Equation (6) is not an integer, thus, a gap timing offset exists between gaps 1910 and 1908.

The amplifier gain setting for the fractional tick at the beginning of gap 1910 is used from MGCB[n] in case gap 1910 is a measurement gap. If there is not enough of a fractional tick at the beginning of gap 1910 to allow for a BBEE measurement, then a default amplifier gain will be updated to MGCB[n+1] 1911, which equals FGCB[n]. Also, if there is not enough of a fractional tick at the beginning of gap 1910, the amplifier gain setting will not change for the fractional tick at the end of gap 1910. Depending on the number of BBEE measurements allowed by the gap timing offset, the updated amplifier gain decisions based on those BBEE measurements will be written to MGCB[n+1], which equals FGCB[n].

In X2L gap scheduling, selective diversity is used for spurious cell pruning. Schedule of A gaps (pipeline AGC initialization only gaps) happens in the beginning of a group of gaps. There is no searching performed in this A gap. After initialization in the A gap, a group of 5 subsequent gaps are used in updating and pruning cells. When the MGCB is empty, AS gaps are scheduled. Otherwise, when the MGCB is not empty, AMS gaps are scheduled. After three of the scheduled gaps in the group, selected cells from the search procedure are updated in the management layer. Pruning occurs when cells have not been selected at least twice within the group of 5 gaps.

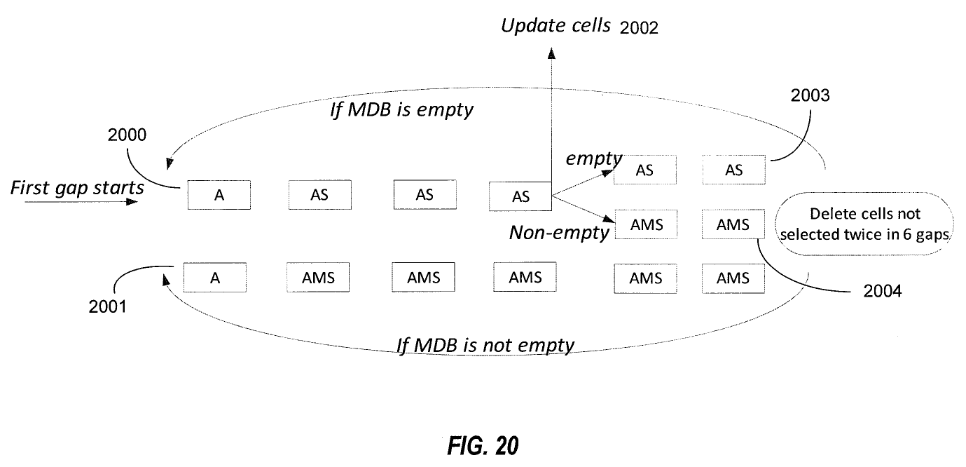

FIG. 20 is a block diagram illustrating X2L Connected mode gap scheduling according to one aspect of the present disclosure. According to the present aspect, A gaps are scheduled in every gap group. Gap group 2000 represents the gap scheduling when the MGCB is empty. Gap group 2001 represents the gap scheduling when the MGCB is not empty. Each of gap groups 2000 and 2001 begin with an A gap. Gap group 2000 follows with multiple AS gaps. After the third AS gap in gap group 2000, the cells are updated at 2002. If the MGCB continues to be empty, then, gap group 2000 finishes with additional AS gaps, illustrated in branch 2003. Otherwise, if the MGCB is not empty after 2002, then gap group 2000 finishes with AMS gaps, illustrated in branch 2004. Pruning still occurs. However, cells are now pruned if they are not selected at least twice in 6 scheduled gaps.

Gap group 2001, in which the MGCB is not empty, schedules AMS gaps to search and measure after the initial A gap. At 2002, the cells are updated. Because the MGCB is not empty, gap group 2001 also finishes with scheduled AMS gaps. Pruning occurs as above, when cells are not selected at least twice in the 6 scheduled gaps.

VCell pruning may also use selective diversity. Selective diversity allows for eliminating spurious cells. Cells may be spurious because of random noise. Cells may also be spurious because of a non-zero correlation between the serving cell (SCell) SSS and other SSS within the downlink area. However, such spurious cells due to the non-zero correlation may not be able to be eliminated by selective diversity. But, it may be assumed that the probability of having a spurious cell in an uplink area is close to zero.

In the first time, the VCell is selected as the cell having the largest SSS SNR. After this initial selection, the VCell is selected as the cell having the largest reference signal receive power (RSRP) after each measurement gap. The measurement database (MDB) will be updated with new cells found in the first 3 scheduled gaps (AS or AMS gaps), as illustrated in FIG. 20. Also, as illustrated, a cell will only be removed at the end of each gap group of 6 gaps.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 10, 17, and 18 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication in a time division duplex (TDD) system, comprising:
preparing, by a mobile device, for reception of one or more synchronization signals in a cell, wherein the mobile device has no knowledge of a timing of the one or more synchronization signals in the cell;
triggering, by the mobile device, selection of a set of pipeline automatic gain control (AGC) processing operations; and
setting, by the mobile device, an amplifier of the mobile device with an amplifier gain setting determined by the selected set of pipeline AGC processing operations.

2. The method of claim 1, wherein the selection of a set of pipeline AGC processing operations includes:
determining, by the mobile device, a mode of operation of the mobile device;
selecting, by the mobile device, the set of pipeline AGC processing operations from a plurality of pipeline AGC processing operations based on the determined mode of operation, wherein the plurality of pipeline AGC processing operations comprises:
a pipeline initialization operation;
a full pipeline operation;
a free amplifier update operation; and
a fixed amplifier operation;
determining, by the mobile device, a current function of the mobile device within the determined mode of operation; and
performing, by the mobile device, an AGC operation of the selected set of pipeline AGC processing operations, wherein the AGC operation performed is associated with the determined current function of the mobile device.

3. The method of claim 2, wherein the AGC operation is performed by the mobile device on a time division duplex (TDD) communication stream divided into one or more processing periods, the method further comprising:
measuring a signal power of one or more downlink symbols in each of the one or more processing periods.

4. The method of claim 3, wherein the AGC operation comprises one of: the pipeline initialization operation or the full pipeline operation, the method further comprising:
determining the amplifier gain setting based on the measured signal power of a current processing period of the one or more processing periods; and
writing the determined amplifier gain setting to a gain circular buffer (GCB) on the mobile device at a location on the GCB corresponding to the current processing period.

5. The method of claim 3, wherein the AGC operation comprises one of: the full pipeline operation or the free amplifier update operation, the method further comprising:
retrieving the amplifier gain setting from a GCB for each of the one or more processing periods; and
applying the retrieved amplifier gain setting at the mobile device for a corresponding one of the one or more processing periods.

6. The method of claim 3, wherein the AGC operation comprises one of: the free amplifier update operation or the fixed amplifier operation, the method further comprising:
preserving current values of a GCB for the one or more processing periods.

7. The method of claim 3, wherein the AGC operation comprises one of: the fixed amplifier operation and the pipeline initialization operation, the method further comprising:
applying a fixed amplifier gain setting at the mobile device for the one or more processing periods.

8. The method of claim 3, wherein the one or more processing periods comprises a timing uncertainty processing period equal in length with a timing uncertainty, wherein the measuring the signal power includes:
setting a downlink measurement window within the timing uncertainty processing period in response to the measuring, wherein the downlink measurement window is less than or equal to a minimum total number of consecutive downlink symbols in relation to a synchronization signal of the TDD communication stream minus the timing uncertainty minus an amplifier required range; and
taking the signal power measurement within the downlink measurement window.

9. The method of claim 8, wherein a downlink pilot time slot (DwPTS) of the TDD communication stream is configured to have 9 or more symbols, the method further comprising:
setting the timing uncertainty to 1 ms.

10. The method of claim 8, wherein a DwPTS of the TDD communication stream is configured to have less than 9 symbols, the method further comprising:
setting the timing uncertainty to 0.5 ms.

11. The method of claim 8, wherein a right edge of the downlink measurement window is set to a right edge offset number of symbols from the amplifier gain setting, wherein the right edge offset number of symbols is determined from the timing uncertainty processing period in a right edge condition with respect to the TDD communication stream, the right edge offset number of symbols being a first number of symbols between a right edge amplifier gain setting and a last known downlink symbol following a closest primary synchronization signal (PSS) in the TDD communication stream.

12. The method of claim 11, wherein a left edge of the downlink measurement window is set to a left edge offset number of symbols from the amplifier gain setting, wherein the left edge offset number of symbols is determined from the timing uncertainty processing period in a left edge condition with respect to the TDD communication stream, the left edge offset number of symbols being a second number of symbols between a previous left edge amplifier gain setting and an earliest known downlink symbol prior to a closest secondary synchronization signal (SSS) in the TDD communication stream.

13. The method of claim 3, wherein the mode of operation comprises one of:
frequency scan (FSCAN) mode;
acquisition mode;
X2L idle mode; and
X2L connected mode.

14. The method of claim 13, wherein the determined mode is the FSCAN mode, the selected set of pipeline AGC processing operations comprising:
the pipeline initialization operation; and
the full pipeline operation.

15. The method of claim 13, wherein the determined mode is the acquisition mode, the selected set of pipeline AGC processing operations comprising:
the pipeline initialization operation;
the free amplifier update operation; and
the fixed amplifier operation.

16. The method of claim 13, wherein the determined mode is the X2L idle mode and a management layer of the mobile device does not provide timing information to a firmware of the mobile device, the selected set of pipeline AGC processing operations comprising:
the pipeline initialization operation;
the free amplifier update operation; and
the fixed amplifier operation.

17. The method of claim 13, wherein the determined mode is the X2L idle mode and a management layer of the mobile device provides timing information to a firmware of the mobile device, the selected set of pipeline AGC processing operations comprising:
the pipeline initialization operation; and
the fixed amplifier operation.

18. The method of claim 13, wherein the determined mode is the X2L connected mode, the selected set of pipeline AGC processing operations comprising:
the pipeline initialization operation;
the free amplifier update operation; and
the fixed amplifier operation.

19. The method of claim 18, further comprising:
entering a gap mode at the mobile device;
determining entry values to a GCB by a management layer of the mobile device based on a type of gap;
sending the GCB and timing information from the management layer of the mobile device to a firmware of the mobile device; and
performing the AGC operation by the firmware during the gap mode.

20. The method of claim 19, wherein the performing the AGC operation by the firmware comprises:
applying, by the firmware, the amplifier gain setting from the GCB to the mobile device for each of the one or more processing periods;
determining an updated amplifier gain setting by the firmware based on the measured signal power;
writing the updated amplifier gain setting to a firmware GCB (FGCB);
reporting the FGCB from the firmware to the management layer prior to exiting the gap mode;
executing, by the firmware, one or both of a search function and a measurement function while in the gap mode; and
reporting results of the executed one or both of the search and measurement functions from the firmware to the management layer.

21. The method of claim 19, wherein a timing offset exists between consecutive gaps, the method further comprising:
applying a partial amplifier gain setting to a first partial processing period of the one or more processing periods of the second gap of the consecutive gaps, wherein the partial amplifier gain setting comprises one of: the amplifier gain setting from the GCB when the second gap is a measurement gap and a default amplifier gain setting; and
maintaining a full amplifier gain setting to a last partial processing period of the one or more processing periods of the second gap, wherein the full amplifier gain setting is applied to a penultimate processing period of the one or more processing periods prior to the last partial processing period.

22. The method of claim 19, further comprising:
scheduling one or more groups of six gaps for the pipeline AGC processing, wherein each of the one or more groups begins with AGC (A) gap, in which only a pipeline initialization operation is performed, wherein remaining ones of the six gaps are scheduled as AGC+search (AS) gaps, when the GCB is empty, and wherein the remaining ones of the six gaps are scheduled as AGC+search+measurement (ASM) gaps, when the GCB is not empty.

23. The method of claim 22, further comprising:
reporting cell updates after three of the remaining ones of the six gaps are completed; and
deleting one or more cells, after completion of a group of gaps of the one or more groups of six gaps, from a list of cells, when the one or more cells are not selected at least twice in the group of gaps.

24. The method of claim 1, further comprising:
preparing, by the mobile device, for reception of one or more additional synchronization signals in an additional cell, wherein the mobile device has no knowledge of a subframe configuration of the one or more additional synchronization signals in the additional cell;
triggering, by the mobile device, another selection of the set of pipeline automatic gain control (AGC) processing operations; and
setting, by the mobile device, the amplifier of the mobile device with a new amplifier gain setting determined by the selected set of pipeline AGC processing operations.

25. An apparatus of pipeline automatic gain control (AGC) processing in wireless communication, comprising:
means for preparing, by a mobile device, for reception of one or more synchronization signals in a cell, wherein the mobile device has no knowledge of a timing of the one or more synchronization signals in the cell;
means for triggering, by the mobile device, selection of a set of pipeline automatic gain control (AGC) processing operations; and
means for setting, by the mobile device, an amplifier of the mobile device with an amplifier gain setting determined by the selected set of pipeline AGC processing operations.

26. The apparatus of claim 25, wherein the selection of a set of pipeline AGC processing operations includes:
means for determining, by the mobile device, a mode of operation of the mobile device;
means for selecting, by the mobile device, the set of pipeline AGC processing operations from a plurality of pipeline AGC processing operations based on the determined mode of operation, wherein the plurality of pipeline AGC processing operations comprises:
a pipeline initialization operation;
a full pipeline operation;
a free amplifier update operation; and
a fixed amplifier operation;
means for determining, by the mobile device, a current function of the mobile device within the determined mode of operation; and
means for performing, by the mobile device, an AGC operation of the selected set of pipeline AGC processing operations, wherein the AGC operation performed is associated with the determined current function of the mobile device.

27. The apparatus of claim 26, wherein the AGC operation is performed by the mobile device on a time division duplex (TDD) communication stream divided into one or more processing periods, the apparatus further comprising:
means for measuring a signal power of one or more downlink symbols in each of the one or more processing periods.

28. The apparatus of claim 27, wherein the AGC operation comprises one of: the pipeline initialization operation or the full pipeline operation, the apparatus further comprising:
means for determining the amplifier gain setting based on the measured signal power of a current processing period of the one or more processing periods; and
means for writing the determined amplifier gain setting to a gain circular buffer (GCB) on the mobile device at a location on the GCB corresponding to the current processing period.

29. The apparatus of claim 27, wherein the AGC operation comprises one of: the full pipeline operation or the free amplifier update operation, the apparatus further comprising:
means for retrieving the amplifier gain setting from a GCB for each of the one or more processing periods; and
means for applying the retrieved amplifier gain setting at the mobile device for a corresponding one of the one or more processing periods.

30. The apparatus of claim 27, wherein the AGC operation comprises one of: the free amplifier update operation or the fixed amplifier operation, the apparatus further comprising:
means for preserving current values of a GCB for the one or more processing periods.

31. The apparatus of claim 27, wherein the AGC operation comprises one of: the fixed amplifier operation and the pipeline initialization operation, the apparatus further comprising:
means for applying a fixed amplifier gain setting at the mobile device for the one or more processing periods.

32. The apparatus of claim 27, wherein the one or more processing periods comprises a timing uncertainty processing period equal in length with a timing uncertainty, wherein the means for measuring the signal power includes:
means for setting a downlink measurement window within the timing uncertainty processing period in response to the means for measuring, wherein the downlink measurement window is less than or equal to a minimum total number of consecutive downlink symbols in relation to a synchronization signal of the TDD communication stream minus the timing uncertainty minus an amplifier required range; and
means for taking the signal power measurement within the downlink measurement window.

33. The apparatus of claim 32, wherein a downlink pilot time slot (DwPTS) of the TDD communication stream is configured to have 9 or more symbols, the apparatus further comprising:
means for setting the timing uncertainty to 1 ms.

34. The apparatus of claim 32, wherein a DwPTS of the TDD communication stream is configured to have less than 9 symbols, the apparatus further comprising:
means for setting the timing uncertainty to 0.5 ms.

35. The apparatus of claim 32, wherein a right edge of the downlink measurement window is set to a right edge offset number of symbols from the amplifier gain setting, wherein the right edge offset number of symbols is determined from the timing uncertainty processing period in a right edge condition with respect to the TDD communication stream, the right edge offset number of symbols being a first number of symbols between a right edge amplifier gain setting and a last known downlink symbol following a closest primary synchronization signal (PSS) in the TDD communication stream.

36. The apparatus of claim 35, wherein a left edge of the downlink measurement window is set to a left edge offset number of symbols from the amplifier gain setting, wherein the left edge offset number of symbols is determined from the timing uncertainty processing period in a left edge condition with respect to the TDD communication stream, the left edge offset number of symbols being a second number of symbols between a previous left edge amplifier gain setting and an earliest known downlink symbol prior to a closest secondary synchronization signal (SSS) in the TDD communication stream.

37. The apparatus of claim 27, wherein the mode of operation comprises one of:
frequency scan (FSCAN) mode;
acquisition mode;
X2L idle mode; and
X2L connected mode.

38. The apparatus of claim 37, wherein the determined mode is the FSCAN mode, the selected set of pipeline AGC processing operations comprising:
the pipeline initialization operation; and
the full pipeline operation.

39. The apparatus of claim 37, wherein the determined mode is the acquisition mode, the selected set of pipeline AGC processing operations comprising:
the pipeline initialization operation;
the free amplifier update operation; and
the fixed amplifier operation.

40. The apparatus of claim 37, wherein the determined mode is the X2L idle mode and a management layer of the mobile device does not provide timing information to a firmware of the mobile device, the selected set of pipeline AGC processing operations comprising:
the pipeline initialization operation;
the free amplifier update operation; and
the fixed amplifier operation.

41. The apparatus of claim 37, wherein the determined mode is the X2L idle mode and a management layer of the mobile device provides timing information to a firmware of the mobile device, the selected set of pipeline AGC processing operations comprising:
the pipeline initialization operation; and
the fixed amplifier operation.

42. The apparatus of claim 37, wherein the determined mode is the X2L connected mode, the selected set of pipeline AGC processing operations comprising:
the pipeline initialization operation;
the free amplifier update operation; and
the fixed amplifier operation.

43. The apparatus of claim 42, further comprising:
means for entering a gap mode at the mobile device;
determining entry values to a GCB by a management layer of the mobile device based on a type of gap;
means for sending the GCB and timing information from the management layer of the mobile device to a firmware of the mobile device; and
means for performing the AGC operation by the firmware during the gap mode.

44. The apparatus of claim 43, wherein the means for performing the AGC operation by the firmware comprises:
means for applying, by the firmware, the amplifier gain setting from the GCB to the mobile device for each of the one or more processing periods;
means for determining an updated amplifier gain setting by the firmware based on the measured signal power;
means for writing the updated amplifier gain setting to a firmware GCB (FGCB);
means for reporting the FGCB from the firmware to the management layer prior to exiting the gap mode;
means for executing, by the firmware, one or both of a search function and a measurement function while in the gap mode; and
means for reporting results of the executed one or both of the search and measurement functions from the firmware to the management layer.

45. The apparatus of claim 43, wherein a timing offset exists between consecutive gaps, the apparatus further comprising:
means for applying a partial amplifier gain setting to a first partial processing period of the one or more processing periods of the second gap of the consecutive gaps, wherein the partial amplifier gain setting comprises one of: the amplifier gain setting from the GCB when the second gap is a measurement gap and a default amplifier gain setting; and
means for maintaining a full amplifier gain setting to a last partial processing period of the one or more processing periods of the second gap, wherein the full amplifier gain setting is applied to a penultimate processing period of the one or more processing periods prior to the last partial processing period.

46. The apparatus of claim 43, further comprising:
means for scheduling one or more groups of six gaps for the pipeline AGC processing, wherein each of the one or more groups begins with AGC (A) gap, in which only a pipeline initialization operation is performed, wherein remaining ones of the six gaps are scheduled as AGC+search (AS) gaps, when the GCB is empty, and wherein the remaining ones of the six gaps are scheduled as AGC+search+measurement (ASM) gaps, when the GCB is not empty.

47. The apparatus of claim 46, further comprising:
means for reporting cell updates after three of the remaining ones of the six gaps are completed; and
means for deleting one or more cells, after completion of a group of gaps of the one or more groups of six gaps, from a list of cells, when the one or more cells are not selected at least twice in the group of gaps.

48. The apparatus of claim 25, further comprising:
means for preparing, by the mobile device, for reception of one or more additional synchronization signals, wherein the mobile device has no knowledge of a subframe configuration of the one or more additional synchronization signals in an additional cell;
means for triggering, by the mobile device, another selection of the set of pipeline automatic gain control (AGC) processing operations; and
means for setting, by the mobile device, the amplifier of the mobile device with a new amplifier gain setting determined by the selected set of pipeline AGC processing operations.

49. A computer program product for wireless communications in a wireless network, comprising:
a non-transitory computer-readable medium having program code recorded thereon, the program code including:
program code for causing a computer to prepare, by a mobile device, for reception of one or more synchronization signals in a cell, wherein the mobile device has no knowledge of a timing of the one or more synchronization signals in the cell;
program code for causing a computer to trigger, by the mobile device, selection of a set of pipeline automatic gain control (AGC) processing operations; and
program code for causing a computer to set, by the mobile device, an amplifier of the mobile device with an amplifier gain setting determined by the selected set of pipeline AGC processing operations.

50. The computer program product of claim 49, wherein the selection of a set of pipeline AGC processing operations includes:
program code for causing a computer to determine, by the mobile device, a mode of operation of the mobile device;
program code for causing a computer to select, by the mobile device, the set of pipeline AGC processing operations from a plurality of pipeline AGC processing operations based on the determined mode of operation, wherein the plurality of pipeline AGC processing operations comprises:
a pipeline initialization operation;
a full pipeline operation;
a free amplifier update operation; and
a fixed amplifier operation;
program code for causing a computer to determine, by the mobile device, a current function of the mobile device within the determined mode of operation; and
program code for causing a computer to perform, by the mobile device, an AGC operation of the selected set of pipeline AGC processing operations, wherein the AGC operation performed is associated with the determined current function of the mobile device.

51. The computer program product of claim 50, wherein the AGC operation is performed by the mobile device on a time division duplex (TDD) communication stream divided into one or more processing periods, the program code further comprising:
program code for causing a computer to measure a signal power of one or more downlink symbols in each of the one or more processing periods.

52. The computer program product of claim 51, wherein the AGC operation comprises one of: the pipeline initialization operation or the full pipeline operation, the program code further comprising:
program code for causing a computer to determine the amplifier gain setting based on the measured signal power of a current processing period of the one or more processing periods; and
program code for causing a computer to write the determined amplifier gain setting to a gain circular buffer (GCB) on the mobile device at a location on the GCB corresponding to the current processing period.

53. The computer program product of claim 51, wherein the AGC operation comprises one of: the full pipeline operation or the free amplifier update operation, the program code further comprising:
program code for causing a computer to retrieve the amplifier gain setting from a GCB for each of the one or more processing periods; and
program code for causing a computer to apply the retrieved amplifier gain setting at the mobile device for a corresponding one of the one or more processing periods.

54. The computer program product of claim 51, wherein the AGC operation comprises one of: the free amplifier update operation or the fixed amplifier operation, the program code further comprising:
program code for causing a computer to preserve current values of a GCB for the one or more processing periods.

55. The computer program product of claim 51, wherein the AGC operation comprises one of: the fixed amplifier operation and the pipeline initialization operation, the program code further comprising:
program code for causing a computer to apply a fixed amplifier gain setting at the mobile device for the one or more processing periods.

56. The computer program product of claim 51, wherein the one or more processing periods comprises a timing uncertainty processing period equal in length with a timing uncertainty, wherein the program code for causing a computer to measure the signal power includes:
program code for causing a computer to set a downlink measurement window within the timing uncertainty processing period in response to the program code for causing a computer to measure, wherein the downlink measurement window is less than or equal to a minimum total number of consecutive downlink symbols in relation to a synchronization signal of the TDD communication stream minus the timing uncertainty minus an amplifier required range; and
program code for causing a computer to take the signal power measurement within the downlink measurement window.

57. The computer program product of claim 56, wherein a downlink pilot time slot (DwPTS) of the TDD communication stream is configured to have 9 or more symbols, the program code further comprising:
program code for causing a computer to set the timing uncertainty to 1 ms.

58. The computer program product of claim 56, wherein a DwPTS of the TDD communication stream is configured to have less than 9 symbols, the program code further comprising:
program code for causing a computer to set the timing uncertainty to 0.5 ms.

59. The computer program product of claim 56, wherein a right edge of the downlink measurement window is set to a right edge offset number of symbols from the amplifier gain setting, wherein the right edge offset number of symbols is determined from the timing uncertainty processing period in a right edge condition with respect to the TDD communication stream, the right edge offset number of symbols being a first number of symbols between a right edge amplifier gain setting and a last known downlink symbol following a closest primary synchronization signal (PSS) in the TDD communication stream.

60. The computer program product of claim 59, wherein a left edge of the downlink measurement window is set to a left edge offset number of symbols from the amplifier gain setting, wherein the left edge offset number of symbols is determined from the timing uncertainty processing period in a left edge condition with respect to the TDD communication stream, the left edge offset number of symbols being a second number of symbols between a previous left edge amplifier gain setting and an earliest known downlink symbol prior to a closest secondary synchronization signal (SSS) in the TDD communication stream.

61. The computer program product of claim 51, wherein the mode of operation comprises one of:
frequency scan (FSCAN) mode;
acquisition mode;
X2L idle mode; and
X2L connected mode.

62. The computer program product of claim 61, wherein the determined mode is the FSCAN mode, the selected set of pipeline AGC processing operations comprising:
the pipeline initialization operation; and
the full pipeline operation.

63. The computer program product of claim 61, wherein the determined mode is the acquisition mode, the selected set of pipeline AGC processing operations comprising:
the pipeline initialization operation;
the free amplifier update operation; and
the fixed amplifier operation.

64. The computer program product of claim 61, wherein the determined mode is the X2L idle mode and a management layer of the mobile device does not provide timing information to a firmware of the mobile device, the selected set of pipeline AGC processing operations comprising:
the pipeline initialization operation;
the free amplifier update operation; and
the fixed amplifier operation.

65. The computer program product of claim 61, wherein the determined mode is the X2L idle mode and a management layer of the mobile device provides timing information to a firmware of the mobile device, the selected set of pipeline AGC processing operations comprising:
the pipeline initialization operation; and
the fixed amplifier operation.

66. The computer program product of claim 61, wherein the determined mode is the X2L connected mode, the selected set of pipeline AGC processing operations comprising:
the pipeline initialization operation;
the free amplifier update operation; and
the fixed amplifier operation.

67. The computer program product of claim 61, wherein the program code further comprises:
program code for causing a computer to enter a gap mode at the mobile device;
program code for causing a computer to determine entry values to a GCB by a management layer of the mobile device based on a type of gap;
program code for causing a computer to send the GCB and timing information from the management layer of the mobile device to a firmware of the mobile device; and
program code for causing a computer to perform the AGC operation by the firmware during the gap mode.

68. The computer program product of claim 67, wherein the program code for causing a computer to perform the AGC operation by the firmware comprises:
program code for causing a computer to apply, by the firmware, the amplifier gain setting from the GCB to the mobile device for each of the one or more processing periods;
program code for causing a computer to determine an updated amplifier gain setting by the firmware based on the measured signal power;
program code for causing a computer to write the updated amplifier gain setting to a firmware GCB (FGCB);
program code for causing a computer to report the FGCB from the firmware to the management layer prior to exiting the gap mode;
program code for causing a computer to execute, by the firmware, one or both of a search function and a measurement function while in the gap mode; and
program code for causing a computer to report results of the executed one or both of the search and measurement functions from the firmware to the management layer.

69. The computer program product of claim 67, wherein a timing offset exists between consecutive gaps, the program code further comprising:
program code for causing a computer to apply a partial amplifier gain setting to a first partial processing period of the one or more processing periods of the second gap of the consecutive gaps, wherein the partial amplifier gain setting comprises one of: the amplifier gain setting from the GCB when the second gap is a measurement gap and a default amplifier gain setting; and
program code for causing a computer to maintain a full amplifier gain setting to a last partial processing period of the one or more processing periods of the second gap, wherein the full amplifier gain setting is applied to a penultimate processing period of the one or more processing periods prior to the last partial processing period.

70. The computer program product of claim 67, wherein the program code further comprises:
program code for causing a computer to schedule one or more groups of six gaps for the pipeline AGC processing, wherein each of the one or more groups begins with AGC (A) gap, in which only a pipeline initialization operation is performed, wherein remaining ones of the six gaps are scheduled as AGC+search (AS) gaps, when the GCB is empty, and wherein the remaining ones of the six gaps are scheduled as AGC+search+measurement (ASM) gaps, when the GCB is not empty.

71. The computer program product of claim 70, wherein the program code further comprises:
program code for causing a computer to report cell updates after three of the remaining ones of the six gaps are completed; and
program code for causing a computer to delete one or more cells, after completion of a group of gaps of the one or more groups of six gaps, from a list of cells, when the one or more cells are not selected at least twice in the group of gaps.

72. The computer program product of claim 49, wherein the program code further comprises:
program code for causing a computer to prepare, by the mobile device, for reception of one or more additional synchronization signals in an additional cell, wherein the mobile device has no knowledge of a subframe configuration of the one or more additional synchronization signals in the neighbor cell;
program code for causing a computer to trigger, by the mobile device, another selection of the set of pipeline automatic gain control (AGC) processing operations; and
program code for causing a computer to set, by the mobile device, the amplifier of the mobile device with a new amplifier gain setting determined by the selected set of pipeline AGC processing operations.

73. An apparatus configured for wireless communication, the apparatus comprising:
at least one processor; and
a memory coupled to the at least one processor,
wherein the at least one processor is configured:
to prepare, by a mobile device, for reception of one or more synchronization signals in a cell, wherein the mobile device has no knowledge of a timing of the one or more synchronization signals in the cell;
to trigger, by the mobile device, selection of a set of pipeline automatic gain control (AGC) processing operations; and
to set, by the mobile device, an amplifier of the mobile device with an amplifier gain setting determined by the selected set of pipeline AGC processing operations.

74. The apparatus of claim 73, wherein the selection of a set of pipeline AGC processing operations includes configuration of the at least one processor:
to determine, by the mobile device, a mode of operation of the mobile device;
to select, by the mobile device, the set of pipeline AGC processing operations from a plurality of pipeline AGC processing operations based on the determined mode of operation, wherein the plurality of pipeline AGC processing operations comprises:
a pipeline initialization operation;
a full pipeline operation;
a free amplifier update operation; and
a fixed amplifier operation;
to determine, by the mobile device, a current function of the mobile device within the determined mode of operation; and
to perform, by the mobile device, an AGC operation of the selected set of pipeline AGC processing operations, wherein the AGC operation performed is associated with the determined current function of the mobile device.

75. The apparatus of claim 74, wherein the AGC operation is performed by the mobile device on a time division duplex (TDD) communication stream divided into one or more processing periods, wherein the at least one processor is further configured:
to measure a signal power of one or more downlink symbols in each of the one or more processing periods.

76. The apparatus of claim 75, wherein the AGC operation comprises one of: the pipeline initialization operation or the full pipeline operation, wherein the at least one processor is further configured:
to determine the amplifier gain setting based on the measured signal power of a current processing period of the one or more processing periods; and
to write the determined amplifier gain setting to a gain circular buffer (GCB) on the mobile device at a location on the GCB corresponding to the current processing period.

77. The apparatus of claim 75, wherein the AGC operation comprises one of: the full pipeline operation or the free amplifier update operation, wherein the at least one processor is further configured:
to retrieve the amplifier gain setting from a GCB for each of the one or more processing periods; and
to apply the retrieved amplifier gain setting at the mobile device for a corresponding one of the one or more processing periods.

78. The apparatus of claim 75, wherein the AGC operation comprises one of: the free amplifier update operation or the fixed amplifier operation, wherein the at least one processor is further configured:
to preserve current values of a GCB for the one or more processing periods.

79. The apparatus of claim 75, wherein the AGC operation comprises one of: the fixed amplifier operation and the pipeline initialization operation, wherein the at least one processor is further configured:
to apply a fixed amplifier gain setting at the mobile device for the one or more processing periods.

80. The apparatus of claim 75, wherein the one or more processing periods comprises a timing uncertainty processing period equal in length with a timing uncertainty, wherein the configuration of the at least one processor to measure the signal power includes configuration:
to set a downlink measurement window within the timing uncertainty processing period in response to the measurement, wherein the downlink measurement window is less than or equal to a minimum total number of consecutive downlink symbols in relation to a synchronization signal of the TDD communication stream minus the timing uncertainty minus an amplifier required range; and
to take the signal power measurement within the downlink measurement window.

81. The apparatus of claim 80, wherein a downlink pilot time slot (DwPTS) of the TDD communication stream is configured to have 9 or more symbols, wherein the at least one processor is further configured:
to set the timing uncertainty to 1 ms.

82. The apparatus of claim 80, wherein a DwPTS of the TDD communication stream is configured to have less than 9 symbols, wherein the at least one processor is further configured:
to set the timing uncertainty to 0.5 ms.

83. The apparatus of claim 80, wherein a right edge of the downlink measurement window is set to a right edge offset number of symbols from the amplifier gain setting, wherein the right edge offset number of symbols is determined from the timing uncertainty processing period in a right edge condition with respect to the TDD communication stream, the right edge offset number of symbols being a first number of symbols between a right edge amplifier gain setting and a last known downlink symbol following a closest primary synchronization signal (PSS) in the TDD communication stream.

84. The apparatus of claim 83, wherein a left edge of the downlink measurement window is set to a left edge offset number of symbols from the amplifier gain setting, wherein the left edge offset number of symbols is determined from the timing uncertainty processing period in a left edge condition with respect to the TDD communication stream, the left edge offset number of symbols being a second number of symbols between a previous left edge amplifier gain setting and an earliest known downlink symbol prior to a closest secondary synchronization signal (SSS) in the TDD communication stream.

85. The apparatus of claim 75, wherein the mode of operation comprises one of:
frequency scan (FSCAN) mode;
acquisition mode;
X2L idle mode; and
X2L connected mode.

86. The apparatus of claim 85, wherein the determined mode is the FSCAN mode, the selected set of pipeline AGC processing operations comprising:
the pipeline initialization operation; and
the full pipeline operation.

87. The apparatus of claim 85, wherein the determined mode is the acquisition mode, the selected set of pipeline AGC processing operations comprising:
the pipeline initialization operation;
the free amplifier update operation; and
the fixed amplifier operation.

88. The apparatus of claim 85, wherein the determined mode is the X2L idle mode and a management layer of the mobile device does not provide timing information to a firmware of the mobile device, the selected set of pipeline AGC processing operations comprising:
the pipeline initialization operation;
the free amplifier update operation; and
the fixed amplifier operation.

89. The apparatus of claim 85, wherein the determined mode is the X2L idle mode and a management layer of the mobile device provides timing information to a firmware of the mobile device, the selected set of pipeline AGC processing operations comprising:
the pipeline initialization operation; and
the fixed amplifier operation.

90. The apparatus of claim 85, wherein the determined mode is the X2L connected mode, the selected set of pipeline AGC processing operations comprising:
the pipeline initialization operation;
the free amplifier update operation; and
the fixed amplifier operation.

91. The apparatus of claim 85, wherein the at least one processor is further configured:
to enter a gap mode at the mobile device;
to determine entry values to a GCB by a management layer of the mobile device based on a type of gap;
to send the GCB and timing information from the management layer of the mobile device to a firmware of the mobile device; and
to perform the AGC operation by the firmware during the gap mode.

92. The apparatus of claim 91, wherein the configuration of the at least one processor to perform the AGC operation by the firmware comprises configuration:
to apply, by the firmware, the amplifier gain setting from the GCB to the mobile device for each of the one or more processing periods;
to determine an updated amplifier gain setting by the firmware based on the measured signal power;
to write the updated amplifier gain setting to a firmware GCB (FGCB);
to report the FGCB from the firmware to the management layer prior to exiting the gap mode;
to execute, by the firmware, one or both of a search function and a measurement function while in the gap mode; and
to report results of the executed one or both of the search and measurement functions from the firmware to the management layer.

93. The apparatus of claim 91, wherein a timing offset exists between consecutive gaps, wherein the at least one processor is further configured:
to apply a partial amplifier gain setting to a first partial processing period of the one or more processing periods of the second gap of the consecutive gaps, wherein the partial amplifier gain setting comprises one of: the amplifier gain setting from the GCB when the second gap is a measurement gap and a default amplifier gain setting; and
to maintain a full amplifier gain setting to a last partial processing period of the one or more processing periods of the second gap, wherein the full amplifier gain setting is applied to a penultimate processing period of the one or more processing periods prior to the last partial processing period.

94. The apparatus of claim 91, wherein the at least one processor is further configured:
to schedule one or more groups of six gaps for the pipeline AGC processing, wherein each of the one or more groups begins with AGC (A) gap, in which only a pipeline initialization operation is performed, wherein remaining ones of the six gaps are scheduled as AGC+search (AS) gaps, when the GCB is empty, and wherein the remaining ones of the six gaps are scheduled as AGC+search+measurement (ASM) gaps, when the GCB is not empty.

95. The apparatus of claim 94, wherein the at least one processor is further configured:
to report cell updates after three of the remaining ones of the six gaps are completed; and
to delete one or more cells, after completion of a group of gaps of the one or more groups of six gaps, from a list of cells, when the one or more cells are not selected at least twice in the group of gaps.

96. The apparatus of claim 73, wherein the at least one processor is further configured:
to prepare, by the mobile device, for reception of one or more additional synchronization signals in an additional cell, wherein the mobile device has no knowledge of a subframe configuration of the one or more additional synchronization signals in the additional cell;
to trigger, by the mobile device, another selection of the set of pipeline automatic gain control (AGC) processing operations; and
to set, by the mobile device, the amplifier of the mobile device with a new amplifier gain setting determined by the selected set of pipeline AGC processing operations.
